(19) United States
(12) Patent Application Publication
(10) Pub. No.: US 2025/0068385 A1
(43) Pub. Date: Feb. 27, 2025

(54) METHOD AND SYSTEM FOR MODIFYING AUDIO CONTENT FOR LISTENER

(71) Applicant: SAMSUNG ELECTRONICS CO., LTD., Suwon-s (KR)

(72) Inventors: Natasha MEENA, Uttar Pradesh (IN); Avinash SINGH, Uttar Pradesh (IN); Mayur AGGARWAL, Uttar Pradesh (IN)

(73) Assignee: SAMSUNG ELECTRONICS CO., LTD., Suwon-s (KR)

(21) Appl. No.: 18/943,176

(22) Filed: Nov. 11, 2024

Related U.S. Application Data
(63) Continuation of application No. PCT/KR2023/006341, filed on May 10, 2023.

(30) Foreign Application Priority Data
May 11, 2022 (IN) 202211027231

(51) Int. Cl. G06F 3/16; G10L 21/028; G10L 25/63

(52) U.S. Cl. CPC G06F 3/165; G06F 3/162; G10L 21/028; G10L 25/63

(57) ABSTRACT

A method for modifying audio content including: determining a crisp emotion value defining an audio object emotion, for each audio object among a plurality of audio objects associated with an audio content, the plurality of audio objects being at least some of a total number of audio objects associated with the audio content; determining a composition factor representing one or more emotions, among a plurality of emotions, in the crisp emotion value of each audio object; calculating a probability of a user associating with each of the one or more emotions represented in the composition factor; and calculating a priority value for each audio object based on the probability of the user associating with the each of the one or more emotions represented in the composition factor of each audio object and the composition factor of each audio object.

### CROSS-REFERENCE TO RELATED APPLICATIONS

This application is a continuation of International Application No. PCT/KR2023/006341, filed on May 10, 2023 and also claims priority to Indian Provisional Patent Application No. 20/221,1027231, filed on May 11, 2022. The disclosures of each of which are incorporated by reference herein in their entireties.

### BACKGROUND

### 1. Field

The disclosure relates to modifying audio content, and particularly relates to modifying the audio content based on a preference of a listener.

### 2. Description of Related Art

While watching content, users may prefer hearing some portion of audio at higher volume while another portion at a lower volume. Further, of the available content, users may like or dislike certain media objects.

Currently, a number of multimedia devices such as televisions and soundbars are using object-based media transfer and rendering techniques. Object based media communication may provide more flexibility in comparison to channel-based system. For each multimedia scene, audio and video objects can be analyzed and encoded in a special way to provide better user experience.

Also, there may some related art which manages audio for better user experience. For example, the related art may include source separation and emotion based processing.

Source separation is a technique to separate an audio into individual components. There are numerous technologies in the related art for source-separation, working mostly based on UNET architecture model.

Emotion Based Processing may make the technology more personalized by making the features more emotion oriented. Existing well-established solutions of emotion detection via audio as well as video (combined or individually) exist using CNN which utilize objective audio/video features to detect emotion contained in them.

However there may be some limitations, such as individuality of audio objects not being focused. The existing solution in this field may modify entire audio parts. As an example: In children specific content, the content marked as adult is either entirely muted or the frames are completely removed. There is may be a need for technology which takes into account a user's emotion profile to automatically enhance, reduce or mute a particular audio object.

There is a need for a solution to overcome the above-mentioned drawbacks.

### SUMMARY

This summary is provided to introduce a selection of concepts in a simplified format that are further described in the detailed description of the present disclosure. This summary is not intended to identify key or essential inventive concepts of the claimed subject matter, nor is it intended for determining the scope of the claimed subject matter. In accordance with the purposes of the disclosure, the present disclosure as embodied and broadly described herein, describes method and system modifying audio content for a listener.

Aspects will be set forth in part in the description which follows and, in part, will be apparent from the description, or may be learned by practice of the presented embodiments.

According to an aspect of the disclosure, a method for modifying audio content, the method may include: determining a crisp emotion value defining an audio object emotion, for each audio object among a plurality of audio objects associated with an audio content, the plurality of audio objects being at least some of a total number of audio objects associated with the audio content; determining a composition factor representing one or more emotions, among a plurality of emotions, in the crisp emotion value of each audio object; calculating a probability of a user associating with each of the one or more emotions represented in the composition factor; calculating a priority value for each audio object based on the probability of the user associating with the each of the one or more emotions represented in the composition factor of each audio object and the composition factor of each audio object; generating a list comprising the plurality of audio objects in a specified order based on the priority value of each audio object among the plurality of audio objects; and modifying the audio content by adjusting a gain of at least one audio object among the plurality of audio objects in the list.

The method may further include: generating a modified audio content by combining a plurality of modified audio objects.

The determining the crisp emotion value for each audio object may include: determining a range of the audio object emotion of the plurality of audio objects by mapping an audio object emotion level for each audio object on a common scale, where the common scale comprises the plurality of emotions; determining a bias of the audio object emotion level for each audio object, where the bias is a minimum value of the range; and determining the crisp emotion value for each audio object by adding the audio object emotion level of each audio object mapped on the common scale to the bias.

The common scale may be one of a hedonic scale and an arousal scale.

The determining the composition factor may include: mapping the crisp emotion value of each audio object on a kernel scale comprising a plurality of adaptive emotion kernels representing the plurality of emotions, where the composition factor is based on a contribution of the one or more emotions among the plurality of emotions represented by one or more adaptive emotion kernels in the crisp emotion value of each audio object.

The method may further include: obtaining a plurality of feedback parameters associated with the user from at least one of a memory and the user in real-time; and adjusting a size of at least one adaptive emotion kernel among the plurality of adaptive emotion kernels based on the plurality of feedback parameters.

The contribution of the one or more emotions may be determined based on the mapping of the crisp emotion value of each audio object on the one or more adaptive emotion kernels.

The calculating the probability of the user associating with the each of the one or more emotions represented in the composition factor may be based on at least one of: a plurality of feedback parameters associated with the user stored in a memory; and a ratio of an area of one or more adaptive emotion kernels corresponding to the each emotion represented in the composition factor and a total area of a plurality of adaptive emotion kernels of the plurality of emotions.

The plurality of feedback parameters may include at least one of a visual feedback, a sensor feedback, a prior feedback, and a manual feedback associated with the user.

The calculating the priority value for the each audio object may include: performing a weighted summation of the probability of the user associating with the each of the one or more emotions represented in the composition factor and the composition factor representing the one or more emotions.

The modifying the audio content by adjusting the gain of at least one audio object may include: performing one or more of: assigning a first gain to an audio object in the list corresponding to a highest priority value and a second gain to another audio object in the list corresponding to a lowest priority value, wherein assigning the second gain corresponds to an audio object being removed from the audio content, and assigning a third gain, greater than the second gain, to the audio object corresponding to a lowest priority value, and the first gain to an audio object corresponding to a highest priority value, wherein assigning the third gain corresponds to an effect of the audio object being changed; calculating a gain of one or more audio objects in the list, other than the audio object with the highest priority value and the other audio object with the lowest priority value, based on a gain associated with an audio object with a priority value higher than the one or more audio objects and a gain associated with the audio object with a priority value lower than the one or more audio objects; and performing a weighted summation of a gain associated with the each audio object in the list for modifying the audio content.

The method may further include receiving the audio content as an input; separating the audio content into the total number of the audio objects; and determining an audio object emotion level for each audio object among the plurality of audio objects.

The separating the audio content into the plurality of audio objects may include: generating a pre-processed audio content by pre-processing the input; generating an output by feeding the pre-processed audio content to a source-separation model; and generating the plurality of audio objects associated with the audio content from the audio content by post-processing the output.

The audio object emotion level of each audio object may be determined by: determining one or more audio features associated with each audio object, where the one or more audio features include at least one of a basic frequency, a time variation characteristic of a frequency, a Root Mean Square (RMS) value associated with an amplitude, and a voice speed associated with each audio object; determining an emotion probability value of each audio object based on the one or more audio features; and determining the audio object emotion level of each audio object based on the emotion probability value.

The method may further include: controlling a speaker to output the modified audio content according to the adjusted gain of the at least one audio object.

According to an aspect of the disclosure, a system for modifying audio content for a listener may include: a memory storing instructions; and at least one processor configure to execute the instructions, wherein, by executing the instructions, the at least one processor is configured to: determine a crisp emotion value defining an audio object emotion, for each audio object among a plurality of audio objects associated with the audio content, the plurality of audio objects being at least some of a total number of audio objects associated with the audio content; determine a composition factor representing one or more emotions in the crisp emotion value of each audio object among a plurality of emotions; calculate a probability of a user associating with each of the one or more emotions represented in the composition factor; calculate a priority value for each audio object based on the probability of the user associating with the each of the one or more emotions represented in the composition factor of each audio object and the composition factor of each audio object; generate a list comprising the plurality of audio objects in a specified order based on the priority value of each audio object among the plurality of audio objects; and modify the audio content by adjusting a gain of at least one audio object among the plurality of audio objects in the list.

The system may further include: an input interface operatively connected to the processor and configured to input the audio content, and a speaker operatively connected to the processor and configured to output sound corresponding to the inputted audio content, where, by executing the instructions, the at least one processor is further configured to: control the speaker to output the modified audio content according to the adjusted gain of the at least one audio object.

According to an aspect of the disclosure, a non-transitory computer-readable information storage medium having instructions stored therein, which, when executed by one or more processors, may cause the one or more processors to: receive, through an input interface, audio content; separate the audio content into a plurality of audio objects; for at least some of the plurality of audio objects, respectively: determine a crisp emotion value defining an audio object emotion, determine a composition factor representing one or more emotions, among the plurality of emotions, in the crisp emotion value, calculate a probability of a user associating with each of the one or more emotions represented in the composition factor, and calculate a priority value based on the probability of the user associating with the each of the one or more emotions represented in the composition factor and the composition factor; generate a list comprising the plurality of audio objects in a specified order based on the priority value of each audio object among the plurality of audio objects; modify the audio content by adjusting a gain of at least one audio object among the plurality of audio objects in the list; control a speaker to output the modified audio content.

The calculating the probability of the user associating with the each of the one or more emotions represented in the composition factor may be based on at least one of: a plurality of feedback parameters associated with the user stored in a memory; and a ratio of an area of one or more adaptive emotion kernels corresponding to the each emotion represented in the composition factor and a total area of a plurality of adaptive emotion kernels of the plurality of emotions.

The separating the audio content into the plurality of audio objects may include: generating a pre-processed audio content by pre-processing the input; generating the output by feeding the pre-processed audio content to a source-separation model; and generating the plurality of audio objects associated with the audio content from the audio content by post-processing the output.

These aspects and advantages will be more clearly understood from the following detailed description taken in conjunction with the accompanying drawings and claims.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 illustrates a flow diagram depicting a method for modifying audio content, in accordance with an embodiment of the disclosure;

FIG. 2 illustrates a schematic block diagram of a system for modifying audio content, in accordance with an embodiment of the disclosure;

FIG. 3 illustrates an operational flow diagram depicting a process for modifying audio content, in accordance with an embodiment of the disclosure;

FIG. 4 illustrates an architectural diagram depicting a method for modifying audio content, in accordance with an embodiment of the disclosure;

FIG. 5A illustrates an operational flow diagram depicting a process for generating a number of audio objects, in accordance with an embodiment of the disclosure;

FIG. 5B illustrates a diagram depicting a U-Net source-separation model, in accordance with an embodiment of the disclosure;

FIG. 5C illustrates a graphical representation of usage of the memory by the U-Net source-separation model, in accordance with an embodiment of the disclosure;

FIG. 5D illustrates a diagram depicting a generation of the number of audio objects in the audio content, in accordance with an embodiment of the disclosure;

FIG. 6A illustrates an operational flow diagram depicting a process for determining an emotion level related to a number of audio objects, in accordance with an embodiment of the disclosure;

FIG. 6B illustrates a diagram depicting a determination of the emotion level associated with the number of audio objects, in accordance with an embodiment of the disclosure;

FIG. 7A illustrates an operational flow diagram depicting a process for determining a crisp emotion value associated with each audio object of audio content, in accordance with an embodiment of the disclosure;

FIG. 7B illustrates a common scale, in accordance with an embodiment of the disclosure;

FIG. 7C illustrates a common scale with the audio object emotion mapped on the common scale to a fixed preset range, in accordance with an embodiment of the disclosure;

FIG. 7D illustrates a diagram depicting a determination of the crisp emotion value, in accordance with an embodiment of the disclosure;

FIG. 8A illustrates an operational flow diagram depicting a process for determining a composition factor, in accordance with an embodiment of the disclosure;

FIG. 8B illustrates a kernel scale, in accordance with an embodiment of the disclosure;

FIG. 8C illustrates a modified kernel scale based on the feedback from the listener, in accordance with an embodiment of the disclosure;

FIG. 8D illustrates an embodiment of the kernel scale depicting a location of the crisp emotion on the kernel scale, in accordance with an embodiment of the disclosure;

FIG. 8E illustrates a diagram depicting the composition factor as the output based on the feedback of the listener and the crisp emotion value for each audio object, in accordance with an embodiment of the disclosure;

FIG. 8F illustrates a graphical representation depicting a height of the at least one adaptive emotion kernel, in accordance with an embodiment of the disclosure.

FIG. 9A illustrates an operational flow diagram depicting a process for an audio object prioritization and gain adjustment, in accordance with an embodiment of the disclosure;

FIG. 9B illustrates a diagram depicting the audio object prioritization and the gain adjustment for generating the modified audio content, in accordance with an embodiment of the disclosure;

FIG. 10 illustrates an architectural diagram of a method to modify audio content including another number of basic emotions, in accordance with an embodiment of the disclosure;

FIG. 11 illustrates a use case diagram depicting a scenario for modifying audio content by enhancing a voice of a singer, in accordance with an embodiment of the disclosure;

FIG. 12 illustrates a use case diagram depicting a scenario of a listener being unable to modify audio content, in accordance with an existing prior-art and a scenario of the listener modifying the audio content, in accordance with an embodiment of the disclosure;

FIG. 13 illustrates a use case diagram depicting a scenario of a listener modifying audio content by managing one or more audio objects, in accordance with an embodiment of the disclosure;

FIG. 14 illustrates a use case diagram depicting a scenario of a listener controlling one or more audio objects of audio content, in accordance with an embodiment of the disclosure;

FIG. 15 illustrates a use case diagram depicting a scenario of a listener enhancing vocals and suppressing a Background Music (BGM) from audio content, in accordance with an embodiment of the disclosure;

FIG. 16 illustrates a use case diagram depicting a scenario of an enhancement of a musical part in audio content, in accordance with an embodiment of the disclosure;

FIG. 17 illustrates a use case diagram depicting a scenario where audio content may be personalized based on an emotion associated with the audio content, in accordance with an embodiment of the disclosure; and

FIG. 18 illustrates a use case diagram depicting a scenario of automatic enhancement of vocals/beats in audio content, in accordance with an embodiment of the disclosure.

Further, skilled artisans will appreciate that elements in the drawings are illustrated for simplicity and may not have been necessarily drawn to scale. For example, the flow charts illustrate the system in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the disclosure and are not intended to be limiting.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, “has,” “having,” “includes,” “including,” or the like, are intended to cover a non-exclusive inclusion, such that a process or system that includes a list of steps does not include only those steps but may include other steps not expressly listed or inherent to such process or system. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

Unless otherwise defined, all technical and scientific terms used herein have the same meaning as commonly understood by one of ordinary skilled in the art to which this invention belongs. The system, systems, and examples provided herein are illustrative only and not intended to be limiting.

Embodiments of the disclosure are described below in detail with reference to the accompanying drawings.

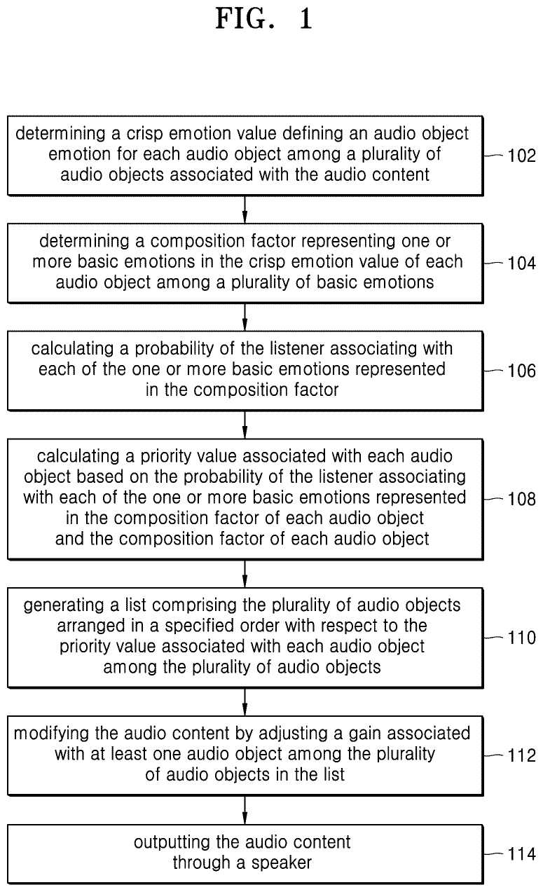

FIG. 1 illustrates a flow diagram depicting a method for modifying audio content, in accordance with an embodiment of the disclosure. Referring to FIG. 1, in an embodiment, the audio content may be modified based on one or more preferences of a listener listening to the audio content. Examples of the audio content may include, but is not limited to, a song, a speech, a narration, and a live coverage of an event. In an embodiment, the audio content may be fetched from a video for modification. In an embodiment, the modification of the audio content may include enhancing or reducing an effect of at least one aspect of the audio content. In an embodiment the at least one aspect may include, a background voice, a tune being played along with the audio content, a background noise, or the like.

In accordance with an embodiment of the disclosure, at step 102, the method 100 may include determining a crisp emotion value defining an audio object emotion for each audio object among a plurality of audio objects associated with the audio content.

Further, at step 104, the method 100 may include determining a composition factor representing one or more basic emotions in the crisp emotion value of each audio object among a plurality of basic emotions.

At step 106, the method 100 may include calculating a probability of the listener associating with each of the one or more basic emotions represented in the composition factor.

At step 108, the method 100 may include calculating a priority value associated with each audio object based on the composition factor of each audio object and the probability of the listener associating with each of the one or more basic emotions represented in the composition factor of each audio object.

At step 110, the method 100 may include generating a list comprising the plurality of audio objects arranged in a specified order with respect to the priority value associated with each audio object among the plurality of audio objects.

At step 112, the method 100 may include modifying the audio content by adjusting a gain associated with at least one audio object among the plurality of audio objects in the list.

At step 114, the method 100 may include outputting the modified audio content through a speaker.

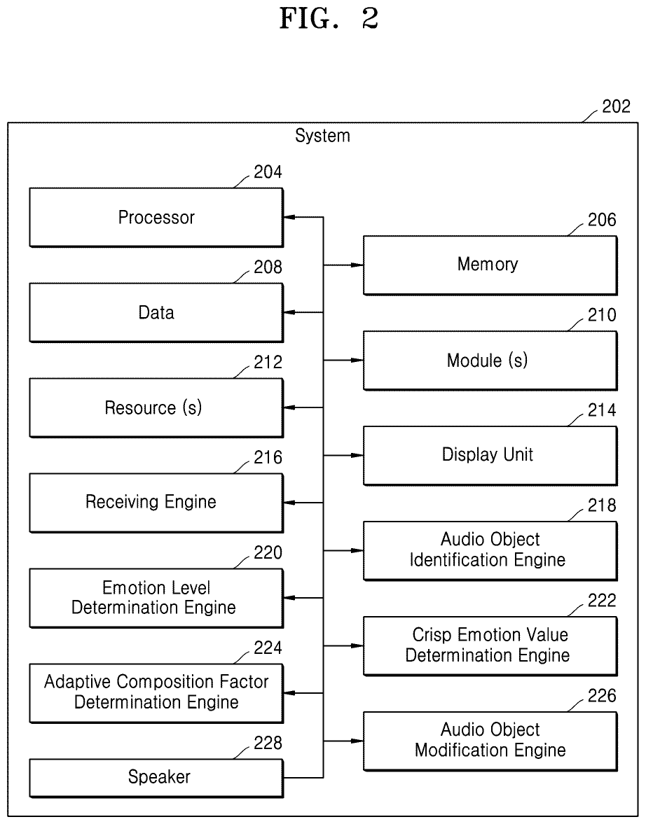

FIG. 2 illustrates a schematic block diagram of a system 202 for modifying audio content, in accordance with an embodiment of the disclosure. Referring to FIG. 2, in an embodiment, the system 202 may be incorporated in a User Equipment (UE). Examples of the UE may include, but not limited to, a television (TV), a laptop, a tab, a smart phone, a Personal Computer (PC), or the like. Examples of the audio content may include, but are not limited to, a song, a speech, a narration, a live coverage of an event, etc. In an embodiment, the audio content may be fetched from a video for modification. In an embodiment, the modification may be based on separating the audio content into a number of audio objects and changing a magnitude of at least one audio object in the audio content. In an embodiment, changing the magnitude may include adjusting a gain associated with the at least one audio object. In an embodiment, adjusting the gain may result in one or more of reducing a magnitude of the at least one audio object, increasing the magnitude of the at least one audio object, and removing the at least one audio object from the audio content. In an embodiment, the modification may be based on one or more preferences of a listener of the audio.

The system 202 may include a processor 204, a memory 206, data 208, module(s) 210, resource(s) 212, a display unit 214, a receiving engine 216, an audio object identification engine 218, an emotion level determination engine 220, a crisp emotion value determination engine 222, an adaptive composition factor determination engine 224, an audio object modification engine 226, and a speaker 228.

In an embodiment, the processor 204, the memory 206, the data 208, the module(s) 210, the resource(s) 212, the display unit 214, the receiving engine 216, the audio object identification engine 218, the emotion level determination engine 220, the crisp emotion value determination engine 222, the adaptive composition factor determination engine 224, and the audio object modification engine 226 may be electrically and/or physically connected to each other.

As would be appreciated, the system 202, may be understood as one or more of a hardware, a software, a logic-based program, a configurable hardware, and the like. In an example, the processor 204 may be a single processing unit or a number of units, all of which may include multiple computing units. The processor 204 may be implemented as one or more microprocessors, microcomputers, microcontrollers, digital signal processors, central processing units, processor cores, multi-core processors, multiprocessors, state machines, logic circuitries, application-specific integrated circuits, field-programmable gate arrays and/or any devices that manipulate signals based on operational instructions. Among other capabilities, the processor 204 may be configured to fetch and/or execute computer-readable instructions and/or data stored in the memory 206.

In an example, the memory 206 may include any non-transitory computer-readable medium known in the art including, for example, volatile memory, such as static random access memory (SRAM) and/or dynamic random access memory (DRAM), and/or non-volatile memory, such as read-only memory (ROM), erasable programmable ROM (EPROM), flash memory, hard disks, optical disks, and/or magnetic tapes. The memory 206 may include the data 208. The data 208 serves, among other things, as a repository for storing data processed, received, and generated by one or more of the processor 204, the memory 206, the data 208, the module(s) 210, the resource(s) 212, the display unit 214, the receiving engine 216, the audio object identification engine 218, the emotion level determination engine 220, the crisp emotion value determination engine 222, the adaptive composition factor determination engine 224, and the audio object modification engine 226.

The module(s) 210, among other things, may include routines, programs, objects, components, data structures, etc., which perform particular tasks or implement data types. The module(s) 210 may also be implemented as, signal processor(s), state machine(s), logic circuitries, and/or any other device or component that manipulate signals based on operational instructions.

Further, the module(s) 210 may be implemented in hardware, as instructions executed by at least one processing unit, e.g., processor 204, or by a combination thereof. The processing unit may be a general-purpose processor that executes instructions to cause the general-purpose processor to perform operations or, the processing unit may be dedicated to performing the required functions. In another aspect of the present disclosure, the module(s) 210 may be machine-readable instructions (software) which, when executed by a processor/processing unit, may perform any of the described functionalities.

In some example embodiments, the module(s) 210 may be machine-readable instructions (software) which, when executed by a processor 204/processing unit, perform any of the described functionalities.

The resource(s) 212 may be physical and/or virtual components of the system 202 that provide inherent capabilities and/or contribute towards the performance of the system 202. Examples of the resource(s) 212 may include, but are not limited to, a memory (e.g., the memory 206), a power unit (e.g., a battery), a display unit (e.g., the display unit 214) etc. The resource(s) 212 may include a power unit/battery unit, a network unit, etc., in addition to the processor 204, and the memory 206.

The display unit 214 may display various types of information (for example, media contents, multimedia data, text data, etc.) to the system 202. The display unit 214 may include, but is not limited to, a liquid crystal display (LCD), a light-emitting diode (LED) display, an organic LED (OLED) display, a plasma cell display, an electronic ink array display, an electronic paper display, a flexible LCD, a flexible electrochromic display, and/or a flexible electrowetting display.

In an example, the receiving engine 216, the audio object identification engine 218, the emotion level determination engine 220, the crisp emotion value determination engine 222, the adaptive composition factor determination engine 224, and the audio object modification engine 226, among other things, may include routines, programs, objects, components, data structures, etc., which perform particular tasks or implement data types. The receiving engine 216, the audio object identification engine 218, the emotion level determination engine 220, the crisp emotion value determination engine 222, the adaptive composition factor determination engine 224, and the audio object modification engine 226 may also be implemented as, signal processor(s), state machine(s), logic circuitries, and/or any other device or component that manipulate signals based on operational instructions.

Further, the receiving engine 216, the audio object identification engine 218, the emotion level determination engine 220, the crisp emotion value determination engine 222, the adaptive composition factor determination engine 224, and the audio object modification engine 226 may be implemented in hardware, instructions executed by a processing unit, or by a combination thereof. The processing unit may be implemented as a computer, a processor, such as the processor 204, a state machine, a logic array or any other suitable devices capable of processing instructions. The processing unit may be a general-purpose processor which executes instructions to cause the general-purpose processor to perform the required tasks or, the processing unit can be dedicated to performing the required functions.

In an embodiment, the receiving engine 216 may be configured to receive the audio content. In an embodiment, the receiving engine 216 may be configured to receive the audio content as an input. In an embodiment, the receiving engine 216 may be configured to receive a video and fetch the audio content from the video by processing the video.

Continuing with the above embodiment, the audio object identification engine 218 may be configured to separate the audio content into the number of audio objects. In an embodiment, the audio object identification engine 218 may be configured to separate the audio content by pre-processing the input to generate a pre-processed audio content. Further, upon pre-processing, the audio object identification engine 218 may be configured to feed the pre-processed audio content to a U-Net based source-separation model to generate a number of outputs. Moving forward, the audio object identification engine 218 may be configured to perform a post processing on the number of outputs to generate the number of audio objects associated with the audio content from the audio content.

Based on the separation of the audio content into the number of audio objects by the audio object identification engine 218, the emotion level determination engine 220 may be configured to determine an audio object emotion level related to each audio object among the number of audio objects. Examples of the audio object emotion may include, but are not limited to, an admiration, an adoration, an appreciation, an amusement, an anger, an anxiety, an awe, an awkwardness, a boredom, a calmness, a confusion, a craving, a disgust, an empathic pain, etc. In an embodiment, the audio object emotion level determination for each audio object by the emotion level determination engine 220 may include determining one or more audio features associated with each audio object.

In an embodiment, the one or more audio features may include a basic frequency, a time variation characteristic of a frequency, a Root Mean Square (RMS) value associated with an amplitude, a voice speed associated with each audio object, etc. In response to determining the one or more audio features, the emotion level determination engine 220 may be configured to determine an emotion probability value associated with each audio object based on the one or more audio features. Continuing with the above embodiment, the emotion level determination engine 220 may be configured to determine the audio object emotion level associated with each audio object based on the emotion probability value.

Continuing with the above embodiment, upon separation of the audio content into the number of audio objects and identification of the audio object emotion level for each of the number of audio object, the crisp emotion value determination engine 222 may be configured to determine a crisp emotion value for each audio object. In an embodiment, the crisp emotion value may define an audio object emotion level for each of the number of audio objects related to the audio content. In an embodiment, for determining the crisp emotion value, the crisp emotion value determination engine 222 may be configured to map the audio object emotion level for each audio object on a common scale to determine a range of the audio object emotion in each audio object. In an embodiment the common scale may include a number of basic emotions. Examples of the number of basic emotions may be 5, the basic emotions may include an extremely sad emotion, a sad emotion, a normal emotion, a happy emotion, and an extremely happy emotion. In an embodiment, the number of basic emotions may be not limited to, the number of basic emotions may vary between 4 and 27. Further, the common scale may be one of a hedonic scale and an arousal scale comprising the number of basic emotions.

To that understanding, in response to determining the range, the crisp emotion value determination engine 222 may be configured to determine a bias for the audio object emotion level for each audio object. In an embodiment, the bias may be a least value of the range as determined above. Furthermore, the crisp emotion value determination engine 222 may be configured to add the audio object emotion level associated with each audio object mapped on the common scale to the bias to determine the crisp emotion value for each audio object.

Continuing with the above embodiment, upon determination of the crisp emotion value for each audio object related to the audio content, the adaptive composition factor determination engine 224 may be configured to determine a composition factor representing one or more basic emotions in the crisp emotion value of each audio object. In an embodiment, the one or more basic emotions may be among the number of basic emotions.

To that understanding, in order to determine the composition factor representing the one or more basic emotion, the adaptive composition factor determination engine 224 may be configured to map the crisp emotion value for each audio object on a kernel scale. In an embodiment, the kernel scale may include a number of adaptive emotion kernels representing the number of basic emotions. In an embodiment, the composition factor representing the one or more basic emotions may be based on a contribution of the one or more basic emotions represented by one or more adaptive emotion kernels in the crisp emotion value for each audio object. In an embodiment, the contribution of the one or more basic emotions may be determined based on a placement of the crisp emotion value for each audio object on the one or more adaptive emotion kernels upon mapping.

Subsequently in an embodiment, the adaptive composition factor determination engine 224 may be configured to adjust a size of at least one adaptive emotion kernel among the number of adaptive emotion kernels. In an embodiment, the size may be adjusted based on a number of feedback parameters related to the listener. Examples of the number of feedback parameters may include, but are not limited to, a visual feedback, a sensor feedback, a prior feedback, a manual feedback related to with the listener, etc. In an embodiment, the adaptive composition factor determination engine 224 may be configured to obtain the number of feedback parameters from at least one of the memory 206 or the listener in real-time. In an embodiment, the number of feedback parameters may be pre-stored in the memory 206. In an embodiment, the listener may be presented with an interface on the UE to share the number of feedback parameters with the system 202.

To that understanding, upon obtaining the number of feedback parameters, the adaptive composition factor determination engine 224 may be configured to adjust the size of the at least one adaptive emotion kernel. In an embodiment, adjusting the size may include increasing or decreasing one or more parameters associated with a shape of the at least one adaptive emotion kernel. Examples of the one or more parameters may include, but are not limited to, a slope, a height, a length, a width, a radius, and an angle of the at least one adaptive emotion kernel.

In an embodiment, based on a determination that the at least one adaptive emotion kernel is in the shape of a trapezium, adjusting the size may include increasing or decreasing one or more of the slope and the height of the at least one adaptive emotion kernel. In an embodiment, based on a determination that the at least one adaptive emotion kernel is in a rectangular shape, adjusting the size may include increasing or decreasing one or more of the length and the width of the at least one adaptive emotion kernel. In an embodiment, based on a determination that the at least one adaptive emotion kernel is in a circular shape, adjusting the size may include increasing or decreasing the radius of the at least one adaptive emotion kernel. In an embodiment, based on a determination that the at least one adaptive emotion kernel is in a triangular shape, adjusting the size may include increasing or decreasing one of the angle and the height of the at least one adaptive emotion kernel.

In an embodiment, increasing the size of the at least one adaptive emotion kernel may indicate that a mood of the listener is similar to at least one basic emotion represented by the at least one adaptive emotion kernel. Further, in an embodiment, decreasing the size of the at least one adaptive emotion kernel may indicate that the mood of the listener is not similar to the at least one basic emotion represented by the at least one adaptive emotion kernel.

Subsequent to determination of the composition factor representing the one or more basic emotion, the audio object modification engine 226 may be configured to calculate a probability of the listener associating with each of the one or more basic emotions represented in the composition factor. In an embodiment, the probability may be calculated by the audio object modification engine 226 based on one of the number of feedback parameters related to the listener and a ratio of an area of the one or more adaptive emotion kernels corresponding to each basic emotion represented in the composition factor and a total area of the number of adaptive emotion kernels of the number of basic emotions.

Continuing with the above embodiment, upon calculating the probability, the audio object modification engine 226 may be configured to calculate a priority value related to each audio object. In an embodiment, the priority value may be based on the probability of the listener associating with each of the one or more basic emotions represented in the composition factor of each audio object and the composition factor representing the one or more basic emotions. In an embodiment, the audio object modification engine 226 may be configured to calculate the priority value by performing a weighted summation of the probability of the listener associating with each basic emotion represented in the composition factor and the composition factor representing the one or more basic emotions. The audio object modification engine 226 may be configured to generate a list comprising the number of audio objects arranged in a specified order with respect to the priority value associated with each audio object among the number of audio objects.

The audio object modification engine 226 may be configured to modify the audio content by adjusting a gain associated with at least one audio object among the number of audio objects in the list. In an embodiment, the audio object modification engine 226 may be configured to perform one or more of a number of steps. In an embodiment, the number of steps may include:
assigning the gain of one to an audio object in the list corresponding to a highest priority value and the gain of zero to another audio object in the list corresponding to a lowest priority value. In an embodiment, assigning the gain of zero may indicate that the other audio object is removed from the audio content; and
assigning the gain of a non-zero value to the audio object corresponding to a lowest priority value and the gain of one to an audio object corresponding to a highest priority value. In an embodiment, assigning the gain of the non-zero value may indicate that an effect of the audio object is changed. In an embodiment, assigning the gain of a value less than 1 and greater than 0 may have an effect of making the audio object sound smaller.

Upon performing the one or more of the number of steps, the audio object modification engine 226 may be configured to calculate the gain associated with one or more audio objects in the list other than the audio object with the highest priority value and the other audio object with the lowest priority value. In an embodiment, the gain associated with the one or more audio objects may be calculated based on the gain associated with the audio object with a priority value higher than the one or more audio objects and the gain associated with the audio object with a priority value lower than the one or more audio objects. In an embodiment, the audio object modification engine 226 may be configured to assign a gain of an audio object that is between the audio object with the highest priority value and the audio object with the lowest priority value in the list as a value between the highest priority value and the lowest priority value, in order of priority. Moving forward, the audio object modification engine 226 may be configured to perform a weighted summation of the gain associated with each audio object in the list for modifying the audio content. Upon modification of the at least one audio object, the audio object modification engine 226 may be configured to combine the number of modified audio objects to generate a modified audio content.

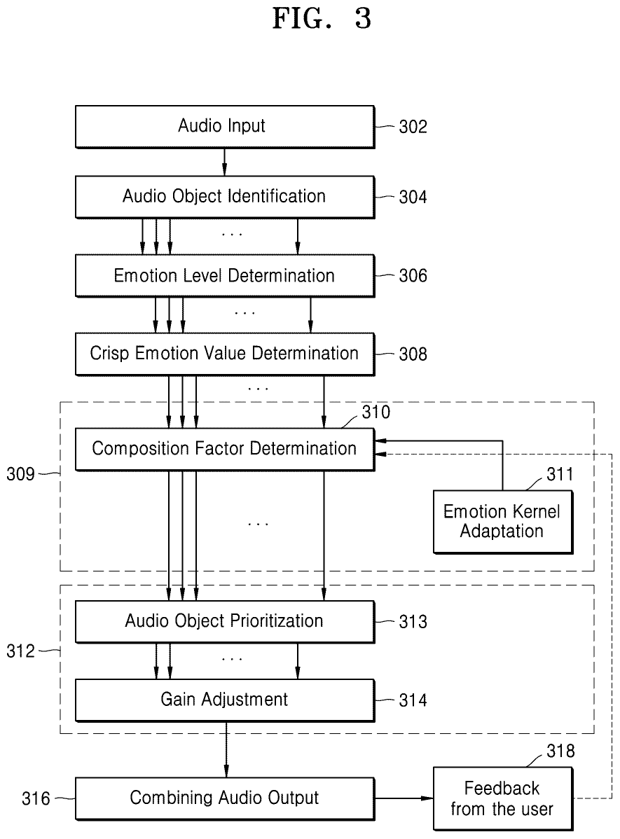

FIG. 3 illustrates an operational flow diagram depicting a process for modifying audio content, in accordance with an embodiment of the disclosure. Referring to FIG. 3, examples of the audio content may include, but are not limited to, a song, a speech, a narration, a live coverage of an event, etc. In an embodiment, the audio content may be fetched from a video for modification. In an embodiment, the modification may be based on separating the audio content into a number of audio objects and changing a magnitude of at least one audio object in the audio content. In an embodiment, changing the magnitude may include adjusting a gain associated with the at least one audio object. In an embodiment, adjusting the gain may result in one or more of reducing a magnitude of the at least one audio object, increasing the magnitude of the at least one audio object, and removing the at least one audio object from the audio content. In an embodiment, the modification may be based on one or more preferences of a listener of the audio.

Continuing with the above embodiment, at step 302, the process may include receiving the audio content as an input.

At step 304, the process may include performing an audio object identification for the audio content. The audio object identification may include separating the audio content into “N” audio objects using ‘lite’ source-separation techniques. In an embodiment, the ‘lite’ source-separation techniques may refer to source separation techniques that are supported by the UE. In an embodiment, the process may include identifying audio emitting objects in the audio/video content. In an embodiment, a particular Audio/Video content may have a human, a drum and car horns as the audio emitting objects, etc. In an embodiment, the “N” audio objects may be the number of audio objects as referred in the FIG. 1 and FIG. 2. In an embodiment, the separation may be performed by the audio object identification engine 218 as referred in the FIG. 2. In an embodiment, the ‘lite’ source separation techniques may be used for separation of the audio content to identify individual audio objects present in the input such as vocals, background music, or the like.

At step 306, the process may include performing an emotion level determination for determining an audio object emotion level and an audio object emotion related to each of the number of audio objects. In an embodiment, the audio object emotion may also interchangeably be referred as an emotion. In an embodiment, the audio object emotion level may be determined using the emotion level determination engine 220 as referred in the FIG. 2. In an embodiment, each audio object may include required information as follows: (human, comic, 7); (drum, happy, 5); (Car Horns, anger, 2). In an embodiment, the audio object emotion level may be a factor between 0 and 10 representing an extremeness of the audio object emotion contained in the object.

At step 308, the process may include performing a crisp emotion value determination for determining a crisp emotion value related to each audio object by remapping the audio object emotion level related to each of the number of audio objects to a common scale of a number of basic emotions by adding a fixed bias. A value of the emotion in common scale is referred to as the crisp emotion value. In an embodiment, the crisp emotion value may be determined by the crisp emotion value determination engine 222 as referred in the FIG. 2. In an embodiment, the basic emotions may include an extremely sad emotion, a sad emotion, a normal emotion, a happy emotion, and an extremely happy emotion. The audio object emotion level of each audio object may be mapped to a crisp emotion value by adding the bias value to the audio object emotion level of each audio object.

At step 309, the process may include performing an adaptive composition factor determination. At step 309, the process may include a step 310 and 311. At step 310, the process may include performing a composition factor determination for determining a composition of each basic emotion in an audio object emotion by using a number of adaptive emotion kernels. In an embodiment, the composition may be a composition factor as referred in the FIG. 1 and FIG. 2. In an embodiment, the composition may be based on a shape related to each of the number of adaptive emotion kernels and the crisp emotion value of each audio object. Step 311 may include the process of performing an emotion kernel adaptation. At step 311, the number of adaptive emotion kernels may be modified based on feedback from the listener. In an embodiment, for a Yes/No based feedback from the listener, one or more parameters of at least one adaptive emotion kernel may increase or decrease by a positive constant amount (Δ). In an embodiment, the composition factor may be determined by the adaptive composition factor determination engine 224 as referred in the FIG. 2. In an embodiment, the composition factor determined for each audio object emotion may be represented as factor of the number of basic emotions compositions.

At step 312, the process may include performing an audio object modification. At step 312, the process may include a step 313 and 314. At step 313, the process may include performing an audio object prioritization associated with the number of audio objects. The audio object prioritization may include determining a probability of the listener's preference for a particular emotion, and a priority value related to each audio object with respect to a preference of each audio object by a listener based on the probability. For determining the priority value, the composition factor may be used to weight the probability of the listener preferring the particular emotion. A weighted summation of such probabilities may determine the priority value of a particular audio object among the number of audio objects. In an embodiment, the priority value for each audio object may be determined by the audio object modification engine 226 as referred in the FIG. 2.

At step 314, the process may include performing a gain adjustment for adjusting gains related to each audio object upon calculating the priority value. In an embodiment, the gain for each audio object may be adjusted to reduce, remove or enhance a particular audio object. In an embodiment, the particular audio object may be the at least one audio object as referred in the FIG. 1 and FIG. 2. In an embodiment, the gains may be adjusted by the audio object modification engine 226.

At step 316, upon adjusting the gains, the process may include combining the number of audio objects and outputting the audio content with adjusted gains to the listener.

At step 318, the process may include obtaining feedback from the listener to adapt kernel shapes of the number of adaptive emotion kernels. Survey-based feedback may be used to determine a preferred profile of the listener for a particular emotion. In an embodiment, a number of other feedback parameters may also be used to determine the preferred profile of the listener. The number of other feedback parameters may include visual feedback, prior feedback, sensor feedback, manual feedback, etc. Feedback may be used to adjust a size of the number of adaptive emotion kernels and also update the probability of the listener liking a particular emotion. In an embodiment, the feedback may be obtained by the composition factor determination engine 224. In an embodiment, adjusting the size may include increasing or decreasing one or more parameters associated with a shape of the number of adaptive emotion kernels. In an embodiment, the one or more parameters may include a slope, a height, a length, a width, a radius, and an angle of the number of adaptive emotion kernels.

In an embodiment, based on a determination that the number of adaptive emotion kernels is in the shape of a trapezium, adjusting the size may include increasing or decreasing one or more of the slope and the height of the number of adaptive emotion kernels. In an embodiment, based on a determination that the number of adaptive emotion kernels is in a rectangular shape, adjusting the size may include increasing or decreasing one or more of the length and the width of the number of adaptive emotion kernels. In an embodiment, based on a determination that the number of adaptive emotion kernels is in a circular shape, adjusting the size may include increasing or decreasing the radius of the number of adaptive emotion kernels. In an embodiment, based on a determination that the number of adaptive emotion kernels is in a triangular shape, adjusting the size may include increasing or decreasing one of the angle and the height of the number of adaptive emotion kernels.

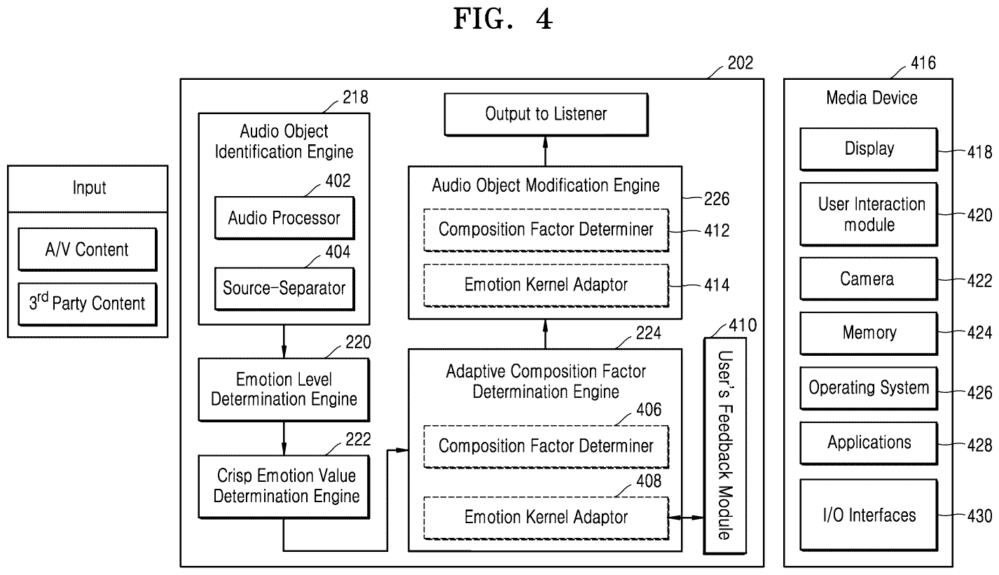

FIG. 4 illustrates an architectural diagram depicting a method for modifying audio content, in accordance with an embodiment of the disclosure. Referring to FIG. 4, in an embodiment, the audio content may be modified based on a preference of a listener listening to the audio content. In an embodiment, the architectural diagram may include the audio object identification engine 218, the emotion level determination engine 220, the crisp emotion value determination engine 222, the adaptive composition factor determination engine 224, and the audio object modification engine 226 as referred in the FIG. 2. Further, the architectural diagram may include a media device 416. In an embodiment, the media device 416 may include a display 418, a user interaction module 420, a camera 422, a memory 424, an operating system 426, one or more applications 428, and one or more input/output interfaces 430. In an embodiment, the memory 424 may be the memory 206 as referred in the FIG. 2. In an embodiment, the method may be performed by the system 202 deploying the system components of the architectural diagram.

The audio object identification engine 218 may be configured to preprocess an input audio. In an embodiment, the input audio may be the audio content received for modification. Further, the audio object identification engine 218 may be configured to perform pre-processing and a source-separation using a pre-trained model on the audio content. Further, the audio object identification engine 218 may be configured to perform a post processing on an output audio generated upon source separation. Upon post processing, the audio object identification engine 218 may be configured to generate a final output. In an embodiment, the final audio may be a source-separated audio separated into a number of audio objects. In an embodiment, the audio object identification engine 218 may include an audio processor 402 for performing the pre-processing and the post-processing. Further, the audio object identification engine 218 may include a source separator 404 for performing the source separation.

Subsequently, the emotion level determination engine 220 may be configured to determine an audio object emotion and an audio object emotion level related to each of the number of audio objects. Moving forward, the crisp emotion value determination engine 222 may be configured to map the audio object emotion to a common scale based on the audio object emotion value and a predefined mapping values of fixed set of audio object emotions.

To that understanding, the adaptive composition factor determination engine 224 may be configured to determine a composition factor of basic human emotion in an identified emotion of audio objects. In an embodiment, the basic human emotion may be among a number of basic emotions as referred in the FIG. 2. The adaptive composition factor determination engine 224 may require adaptive emotion kernels adapted according to an emotion response of the listener. In an embodiment, the adaptive emotion kernels may be a number of adaptive emotion kernels as referred in the FIG. 2. In an embodiment, the adaptive composition factor determination engine 224 may include a composition factor determiner 406 for determining the composition factor and an emotion kernel adapter 408 for adapting the number of adaptive emotion kernel based on the emotion response of the listener received from a user feedback module 410.

The audio object modification engine 226 may be configured to determine a priority value of each audio object depending on the composition factor and a shape of the adaptive emotion kernels. Further, the audio object modification engine 226 may be configured to adjust gains associated with each audio object to enhance or reduce effect of at least one audio object in the order of the priority related to each of the number of audio objects. In an embodiment, the audio object modification engine 226 may include an audio object prioritization engine 412 for determining the priority value and a gain adjuster 414 for performing the gain adjustment.

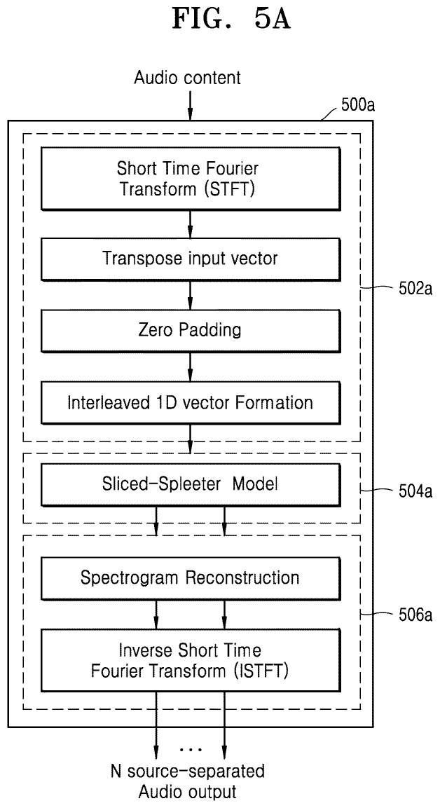

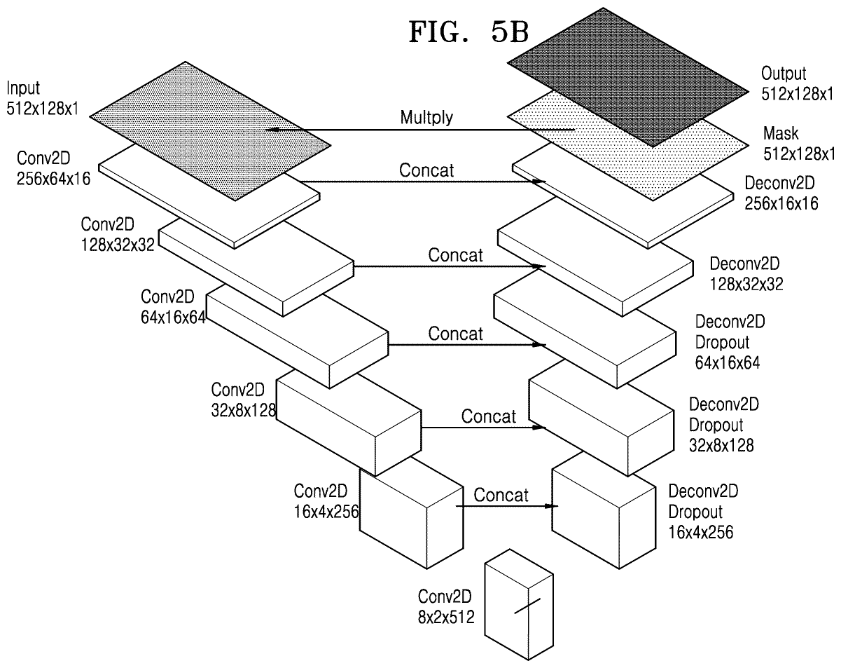

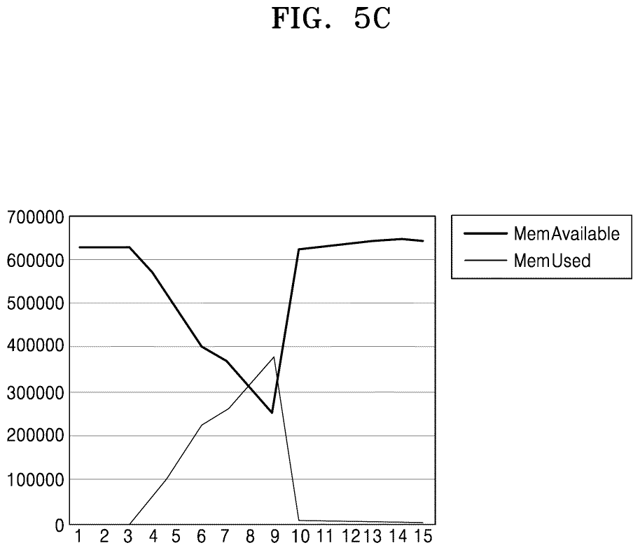

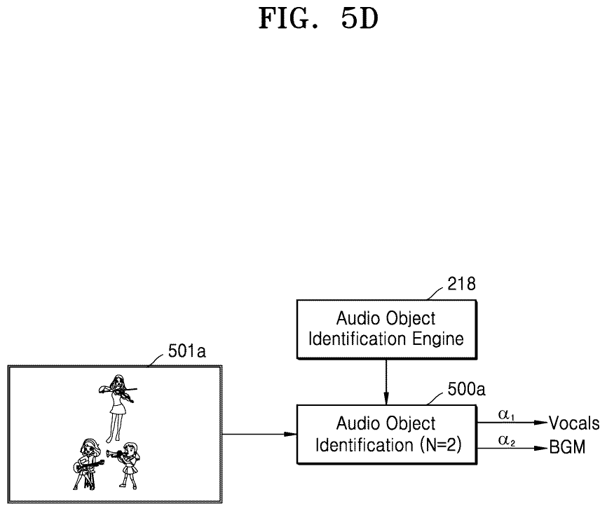

FIG. 5A illustrates an operational flow diagram 500a depicting a process for generating a number of audio objects, in accordance with an embodiment of the disclosure. Referring to FIG. 5A, in an embodiment, audio content may be received as input at the system 202 as referred in the FIG. 2 and the audio content may be separated into the number of audio objects as an output. In an embodiment, the output as the number of audio objects may be referred as ‘at’ such that aᵢ, 1≤i≤N, ‘N’ may be the number of audio objects.

In an embodiment, the audio content may be separated into the number of audio objects by the audio object identification engine 218 as referred in the FIG. 2. Examples of the number of audio objects may include, but are not limited to, a vocal, a background, a music or the like. In an embodiment, the audio object identification engine 218 may be configured to perform a source-separation on the audio content and to generate N source-separated audio outputs aᵢ, 1≤i≤N. In an embodiment, a value of ‘N’ may depend on a model used for performing the source separation to generate the number of audio objects from the audio content. In an embodiment, the disclosure may utilize a modified version of a U-Net source-separation model. In an embodiment, the “U-Net source-separation model may be a “Spleeter” model.

In an embodiment, the process may include a step 502a. At step 502a, the process may include performing a pre-processing of the audio content in response to receiving the audio content as the input. In an embodiment, the pre-processing may include:

Determining a Short Time Fourier Transform (STFT) of the input audio content; and

Performing a transpose operation on an input vector of the audio content, zero padding, and interleaving (to bring in expected shape).

The process may include a step 504a. At step 504a, the process may include proceeding towards feeding the pre-processed audio content to the U-Net source-separation model U-Net source-separation model to generate an output based on the pre-processed audio content.

Continuing with the above embodiment, the process may include a step 506a. At step 506a, the process may include performing a post-processing on the output generated by the U-Net source-separation model to generate a new output. In an embodiment, the post-processing may include:

A spectrogram reconstruction i.e., accessing interleaved output to construct a 2D vector; and

An inverse STFT of the output audio chunk.

In an embodiment, the new output generated may be pulse-code modulation data (PCM data) related to the source-separated audio content. In an embodiment, a length of the audio content may depend on a minimum length of an input required for processing by the model. In an embodiment, minimum ranges may be in order of seconds.

FIG. 5b illustrates a diagram depicting the U-Net source-separation model, in accordance with an embodiment of the disclosure. Referring to FIG. 5B, in an embodiment, a commonly and widely used source-separation model may be a U-Net source-separation model that works based on a UNET architecture, utilizing audio features such as spectrogram. The value of N as mentioned above may depend on a number of stems present in the source-separation model. In an embodiment, the U-Net source-separation model may be configured to generate a minimum of 2 to a maximum of 5 source-separated outputs. One or more embodiments of the disclosure may employ the modified version of the U-Net source-separation model. In an embodiment, the U-Net source-separation model may be a modified model as used in the disclosure. In an embodiment, modification may include removing one or more unsupported layers/nodes and process the one or more unsupported layers/nodes separately outside of a Tensorflow lite model as a part of pre-processing. In an embodiment, the modification may further include removing layers from a Spleeter Tensorflow model involving un-supported operators and perform such steps externally using normal mathematical operations. Further, a conversion of the sliced model to the Tensorflow lite may be performed with only built-in Tensorflow lite operators.

FIG. 5c illustrates a graphical representation of usage of the memory 206 by the U-Net source-separation model, in accordance with an embodiment of the disclosure. Referring to FIG. 5c, in an embodiment, x-axis may be an invoke time, y-axis may be an memory usage. In an embodiment, a memory usage may be a function of model size, remaining substantially constant after the U-Net source-separation model and an interpreter are loaded. Furthermore, an invoke time may be of an order of length of the input audio content. In an embodiment, an ‘n’ seconds of input may need less than or equal to ‘n’ seconds of invoke time.

FIG. 5D illustrates a diagram depicting a generation of the number of audio objects in the audio content 501a, in accordance with an embodiment of the disclosure. Referring to FIG. 5D, in an embodiment, the audio content 501a may include two source separated audio objects such as vocals (a1) and BackGround Music (BGM) (a2). In an embodiment, the two source separated audio objects may be an output of a two stem (N=2) model.

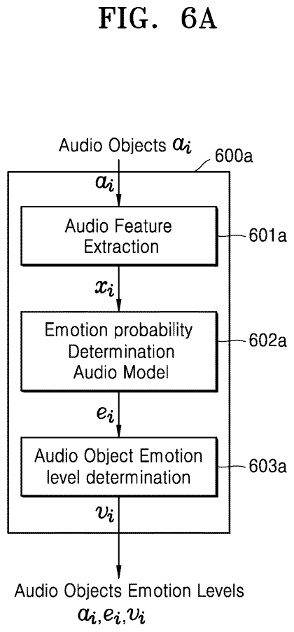

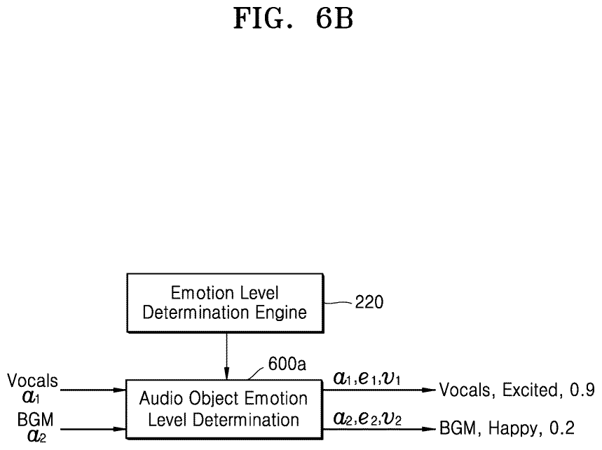

FIG. 6A illustrates an operational flow diagram 600a depicting a process for determining an audio object emotion level related to a number of audio objects, in accordance with an embodiment of the disclosure. Referring to FIG. 6a, in an embodiment, the number of audio objects may be generated by separating audio content. In an embodiment, the audio object emotion level for each audio object may be determined to further determining a crisp emotion value associated with the number of audio objects. In an embodiment, the audio object emotion level for each audio object may be determined by the audio object emotion level determination engine 220 as referred in the FIG. 2.

In an embodiment, the audio object emotion level determination engine 220 may receive the number of audio objects as an input. In an embodiment, the number of audio objects may be “N”. Further, the audio object emotion level determination engine 220 may be configured to determine the audio object emotion level for each audio object as an output. In an embodiment, the audio object emotion level determination engine 220 may also be configured to determine an emotion present in source separated audio content. In an embodiment, the source separated audio content may be the number of audio objects. In an embodiment, the audio content in an audio object may be referred as at, the emotion and the audio object emotion level for each audio object may be referred as e; and vi, respectively.

In accordance with an embodiment of the disclosure, the process may include a step 601a. At step 601a, the process may include determining a number of audio features associated with the audio content. In an embodiment, the number of audio features may be one of a basic frequency, a time variation characteristic of the fundamental frequency, a Root Mean Square (RMS) value of an amplitude, a voice speed or the like. The process may include a step 602a. At step 602a, the process may include determining an audio emotion probability for the number of audio objects using an emotion probability determination audio model. In an embodiment, the emotion probability determination audio model may include one or more statistical models pre-configured using learning audio data or video data such as a Hidden Markov model or the like. In an embodiment, the audio emotion probability may be a direct measure of the audio object emotion level, vi, representing an extremeness of an audio object emotion. Examples of the audio object emotion may include, but are not limited to, an admiration, an adoration, an appreciation, an amusement, an anger, an anxiety, an awe, an awkwardness, a boredom, a calmness, a confusion, a craving, a disgust, an empathic pain, a sadness, a normal emotion, a happy emotion, etc. In an embodiment, the process may include a step 603a. At step 603a, the process may include determining the audio object emotion level.

FIG. 6b illustrates a diagram depicting a determination of the audio object emotion level associated with the number of audio objects, in accordance with an embodiment of the disclosure. Referring to FIG. 6b, in an embodiment, the audio object emotion level determination engine 220 may receive the number of audio objects such as vocals (a1) and a BGM (a2). Further, an output may be generated depicting the emotion and the audio object emotion level associated with the number of audio objects representing extremeness of the emotion, 0<v<1, 0—moderate, 1—extreme. In an embodiment, the output for the emotion and the audio object emotion level for the vocals may be an excited emotion and 0.9 audio object emotional value. In an embodiment, the output for the emotion and audio object emotion level for the BGM may be a happy emotion and 0.2 audio object emotional value.

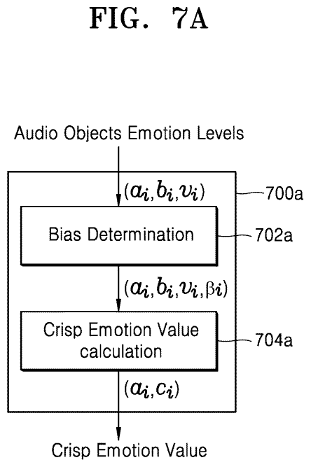

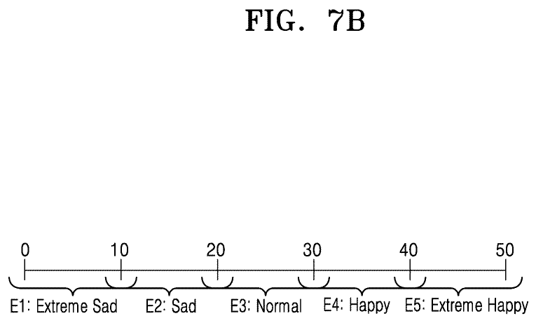

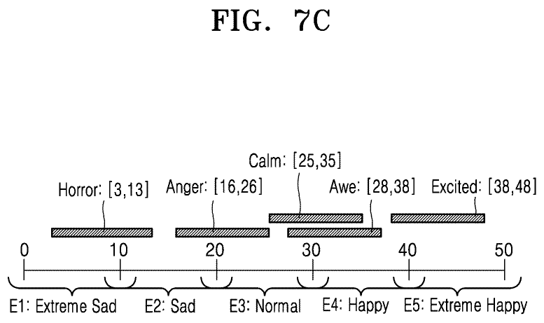

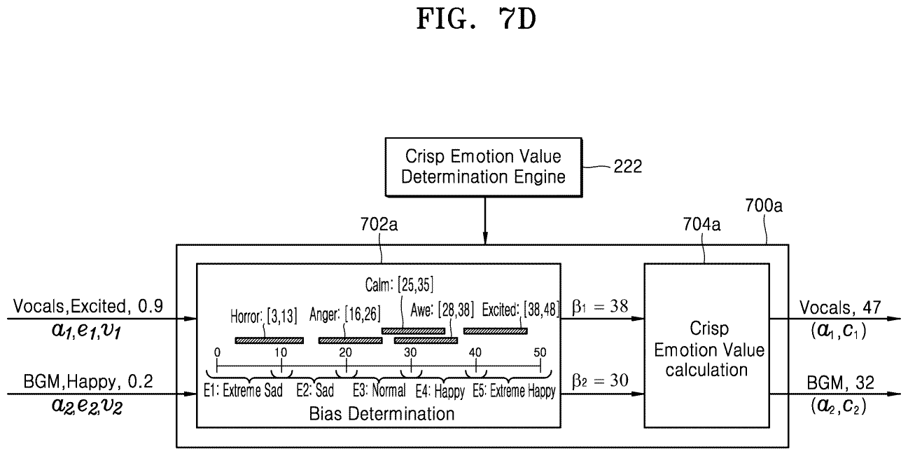

FIG. 7a illustrates an operational flow diagram 700a depicting a process for determining a crisp emotion value associated with each audio object of audio content, in accordance with an embodiment of the disclosure. Referring to FIG. 7a, in an embodiment, the crisp emotion value may define an audio object emotion for each audio object among a number of audio objects associated with the audio content as depicted in FIG. 1. In an embodiment, the crisp emotion value for each audio object may be determined by the crisp emotion value determination engine 222 as referred in the FIG. 2. In an embodiment, the crisp emotion value for each audio object may be determined based on a mapping of an audio object emotion level associated with each audio object on a common scale. In an embodiment, the common scale may be one of a hedonic scale and an arousal scale. In an embodiment, the common scale may include a number of basic emotions. Examples of the number of basic emotions may include, but are not limited to, an extremely sad emotion, a sad emotion, a normal emotion, a happy emotion, and an extremely happy emotion.

Continuing with the above embodiment, the crisp emotion value determination engine 222 may be configured to receive the audio object emotion level vᵢ related to each of the number of audio objects as an input and determine the crisp emotion value cᵢ for each audio object as an output. In an embodiment, the crisp emotion value determination engine 222 may be configured to re-quantify each pair of each audio object and the audio object emotion level related with each audio object to the common scale including the number of basic emotions such that an absolute position of each audio object may be determined on the common scale. In an embodiment, the hedonic scale may be used with the number of basic emotions such as an extremely sad emotion, a sad emotion, a normal emotion, a happy emotion, and an extremely happy emotion. In an embodiment, an aim of the crisp emotion value determination engine 222 may be to find the position of a given emotion-value pair in a common scale of 0 to 50. The number 0 to 50 may just be a representative of a range of a particular emotion on the common scale.

Continuing with the above embodiment, the process may include a step 702a. At step 702a, the process may include determining, by the crisp emotion value determination engine 222, a bias βᵢ corresponding to the audio object emotion level of each audio object received as the input. In an embodiment, determining the bias may be based on maintaining a list of the several yet limited emotions which could be the output of an emotion level determination such as horror, anger, awe, excited, calm or the like. In an embodiment, determining the bias may further include mapping each emotion of an audio object onto the range of common scale such that:

Each emotion eᵢ must be mapped to a range Rᵢ:[aᵢ, bᵢ) on the common scale of emotion, where aᵢ, bᵢ∈[0, 50] and bᵢ−aᵢ≥10.

The mapping may be a fixed knowledge and may be treated as a predetermined constant.

In response to determining the range, the bias may be calculated as:
βᵢ=aᵢ, where aᵢ is minimum of Range Rᵢ:[aᵢ, bᵢ) for mapping of emotion eᵢ

Continuing with the above embodiment, the process may include a step 704a. At step 704a, the process may include determining the crisp emotion value based on an equation 1:

$${c}_{i} = {β}_{i} + {v}_{i} \times 10 ,$$

Where crisp value is a measure of position of emotion eᵢ on the common scale of emotion, the emotion value vᵢ is incorporated in the audio object aᵢ.

In an embodiment, the crisp emotion value may be a re-map of the audio object emotion level in an individual audio object from the number of audio objects to the common scale. In an embodiment, the crisp emotion value may be useful in quantizing a number of audio emotions as a factor of at least one basic human emotion and quantifying a priority by taking into account emotional preference of a listener. In an embodiment, the at least one basic human emotion may be among the number of basic emotions.

FIG. 7b illustrates a common scale, in accordance with an embodiment of the disclosure. Referring to FIG. 7b, in an embodiment, the common scale may be the common scale with the number of basic emotions, such as the extremely sad emotion, the sad emotion, the normal emotion, the happy emotion, the extremely happy emotion, etc. In an embodiment, the number of basic emotions may include the range (0 to 50) as depicted in the FIG. 7b.

FIG. 7c illustrates a common scale with the audio object emotion mapped on the common scale to a fixed preset range, in accordance with an embodiment of the disclosure. Referring to FIG. 7c, in an embodiment, the audio object emotion, such as horror, anger, awe, exited, calm or the like, may be mapped on the common scale to a fixed preset range.

FIG. 7d illustrates a diagram depicting a determination of the crisp emotion value, in accordance with an embodiment of the disclosure. Referring to FIG. 7d, in an embodiment, the crisp emotion value determination engine 222 may receive the number of audio objects such as vocals and BGM, the emotion and the audio object emotion level associated with each audio object. The emotion and emotion value for the vocals may be an excited emotion and a 0.9 audio object emotion value, and the emotion and the emotion value for the BGM may be a happy emotion and a 0.2 audio object emotion value. Further, a bias determined for each audio object may be 38 and 30. Moving forward, the crisp emotion value may be generated for each audio object such that the crisp emotion value for vocals may be 47 and the crisp emotion value for the BGM may be 32.

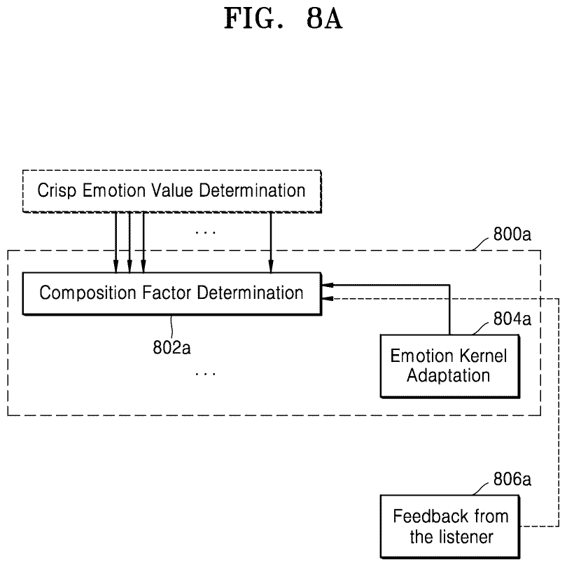

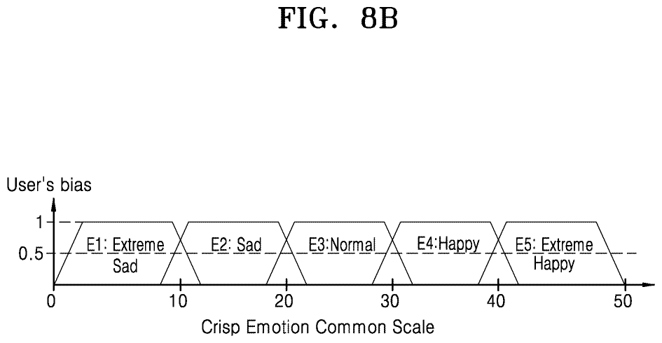

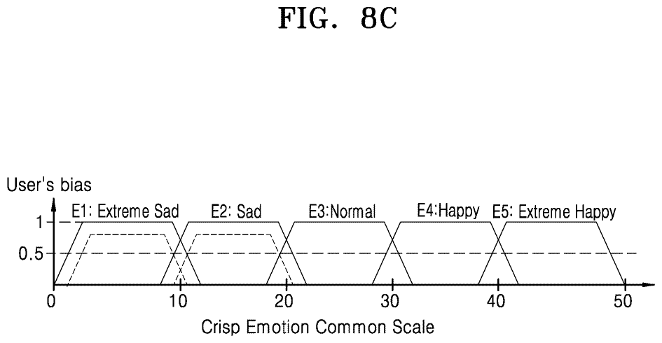

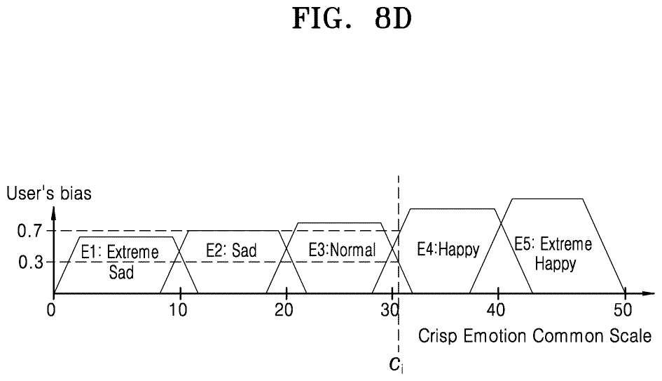

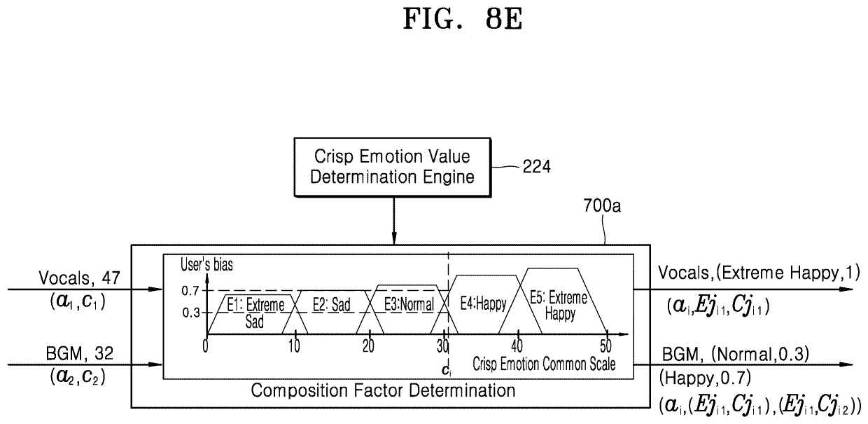

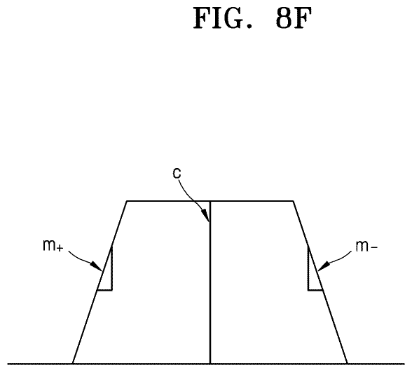

FIG. 8a illustrates an operational flow diagram 800a depicting a process for determining a composition factor, in accordance with an embodiment of the disclosure. FIG. 8b illustrates a kernel scale, in accordance with an embodiment of the disclosure. FIG. 8c illustrates a modified kernel scale based on the feedback from the listener, in accordance with an embodiment of the disclosure. FIG. 8d illustrates an embodiment of the kernel scale depicting a location of the crisp emotion on the kernel scale, in accordance with an embodiment of the disclosure. FIG. 8e illustrates a diagram depicting the composition factor as the output based on the feedback of the listener and the crisp emotion value for each audio object, in accordance with an embodiment of the disclosure. FIG. 8f illustrates a graphical representation depicting a height of the at least one adaptive emotion kernel, in accordance with an embodiment of the disclosure. Referring to FIG. 8a, 8b, 8c, 8d, 8e, 8f, in an embodiment, the composition factor may be representing one or more basic emotions among a number of basic emotions in a crisp emotion value of each audio object as depicted in FIG. 1. In an embodiment, the composition factor may be determined in an audio object emotion associated with each audio object from a number of audio objects of audio content. In an embodiment, the composition factor may be determined by the adaptive composition factor determination engine 224 as referred to in FIG. 2. In an embodiment, the composition factor may be determined based on a number of adaptive emotion kernels present on a kernel scale and a crisp emotion value for each audio object.

In an embodiment, the process may include a step 802a. At step 802a, the process may include determining the composition factor by the adaptive composition factor determination engine 224. The adaptive composition factor determination engine 224 may be configured to receive the crisp emotion value for each of the number of audio objects as an input (aᵢ, cᵢ), 1≤i≤N. In response, the adaptive composition factor determination engine 224 may be configured to determine the composition factor (aᵢ, (Ejᵢ, Cjᵢ)), 1≤i≤N, 1≤j≤M. In an embodiment, ‘N’ may be the number of audio objects, “M” may be the number of basic emotions. In an embodiment, ‘j’ may be the one or more basic emotions among the number of basic emotions “M” in the crisp emotion value of each audio object. In an embodiment, the number of basic emotions “M” may be 5. In an embodiment, the number of basic emotions “M” may vary between 4 and 27.

In an embodiment, mathematically, the composition factor Cjᵢ may be defined as a percentage composition of a basic emotion Ejᵢ among the number of basic emotions present in the crisp emotion value cᵢ of each audio object aᵢ, where 1≤i≤N, 1≤j≤M.

For determining the composition factor, the number of adaptive emotion kernels may be required. In an embodiment, each emotion kernel may be a representative shape of a bias of a listener towards each basic emotion represented by each of the number of adaptive emotion kernels. In an embodiment, a size of the number of adaptive emotion kernels represent an illustrative measure of the bias of the listener towards one of the number of the basic emotions such as E1: extremely sad, E2: sad, E3: neutral, E4: happy and E5: extremely happy. In an embodiment, E1, E2, E3, E4, and E5 may be the number of adaptive emotion kernels.

In an embodiment, the process may include a step 804a. At step 804a, the process may include adjusting the size of the number of adaptive emotion kernels. In an embodiment, adjusting the size of the number of adaptive emotion kernels may include increasing or decreasing one or more parameters associated with a shape of the number of adaptive emotion kernels. In an embodiment, the one or more parameters may include a slope, a height, a length, a width, a radius, and an angle of the number of adaptive emotion kernels.

In an embodiment, based on a determination that the number of adaptive emotion kernels is in the shape of a trapezium, adjusting the size may include increasing or decreasing one or more of the slope and the height of the number of adaptive emotion kernels. In an embodiment, based on a determination that the number of adaptive emotion kernels is in a rectangular shape, adjusting the size may include increasing or decreasing one or more of the length and the width of the number of adaptive emotion kernels. In an embodiment, based on a determination that the number of adaptive emotion kernels is in a circular shape, adjusting the size may include increasing or decreasing the radius of the number of adaptive emotion kernels. In an embodiment, based on a determination that the number of adaptive emotion kernels is in a triangular shape, adjusting the size may include increasing or decreasing one of the angle and the height of the number of adaptive emotion kernels.

In an embodiment, the process may include a step 806a. At step 806a, the process may include changing the size of each adaptive emotion kernel according to feedback from the listener. In an embodiment, a shape of each of the number of adaptive emotion kernels may be adapted by changing the size of each adaptive emotion kernel according to an interest of the listener. Feedback from the listener as a positive feedback or negative feedback may be taken using one or more of following methods of inputting information:

Visual Feedback: Given visual data of the listener watching the content is available, the feedback maybe perceived from the expression on a face of the listener through a camera or the like.

Sensor Feedback: Based on the level of data available with a processor, such as the data of smart watch of the listener, the data may be used to conclude a reaction of the current automated listener as the positive or negative feedback.

Prior Feedback: Knowledge such as past volume control behavior corresponding the past audio emotions, may be recorded and used as a prior knowledge to automatically understand the expected behavior of the listener at a current time.

Manual Feedback: Apart from the above-mentioned automated ways of taking feedback, another way could be to manually ask the listener about the feedback about preferring a particular emotion. In an embodiment, the particular emotion may be among the number of audio object emotion.

Once the feedback from the listener in terms of positive or negative is received for a particular basic emotion among the number of basic emotions, shape of one or more of the number of adaptive emotion kernels may need to be adapted according to the interest of the listener.

The steps of adaptation may include:

Starting with a basic shape of the number of adaptive emotion kernel for each listener. In an embodiment, the basic shape may be a default shape for each of the number of adaptive emotion kernels.

Based on the positive or the negative feedback from the listener recorded by any of the mentioned ways, the one or more adaptive emotion kernels may be adapted as follows:

$${m}_{+} = {m}_{+} + Δ ,$$

$${m}_{-} = {m}_{-} - Δ ,$$

$$c = c + Δ$$

$$where Δ = \{ \begin{matrix}ε > 0 , for a Yes based feedback of user \\ ε < 0 , for a No based feedback of user\end{matrix} {m}_{+} is the positive$$

slope of the kernel, m₋ is the negative slope of the kernel, c is the height of the kernel, and ε is a small constant as depicted in the FIG. 8f.

In an embodiment, the one or more adaptive emotion kernels may be shaped in the form of a trapezium.

In an embodiment, if the listener does not like hearing extreme sad/sad emotion, based on the feedback of the listener, the one or more adaptive emotion kernels may be adapted.

Moving forward, in response to adaption of the one or more adaptive emotion kernels based on the feedback, the composition factor may be determined based on the crisp emotion values ci for the number of audio objects ai by locating the crisp emotion value on the kernel scale for each audio object among the number of audio objects. Based on the location of the crisp emotion value of each audio object on the kernel scale, a percentage contribution of the number of basic emotions may be determined.

Referring to FIG. 8b, in an embodiment, the kernel scale may include the number adaptive emotion kernels representing the number of basic emotions. In an embodiment, a base shape also referred as the default shape of the adaptive emotion kernel scale may be as shown, for the bias of a constant listener for each of the number of basic emotions.

Referring to FIG. 8c, in an embodiment, if the listener does not like hearing the extreme sad or the sad emotion, based on the feedback the number of adaptive emotions kernels may be updated as depicted in the FIG. 8c.

Referring to FIG. 8d, based on the location of the crisp emotion value ci, the percentage contribution of the one or more basic emotions may be found. In an embodiment, the percentage contribution of the number of basic emotions Ej:1≤j≤M; for the crisp emotion value cᵢ for an audio object a; are as follows in the table 2:

| Ej | Emotion | Cj: Contribution Factor |
|---|---|---|
| E1 | Extreme sad | 0 |
| E2 | Sad | 0 |
| E3 | Normal | 0.3 (30%) |
| E4 | Happy | 0.7 (70%) |
| E5 | Extreme Happy | 0 |

Table 2 depicts contribution of the number of basic emotions in the composition factor

In an embodiment, the number of adaptive emotion kernels play an important part in determining the composition factor by symbolizing that “emotions are subjective in nature” such that “What may be sad for one, may not be that sad for other.” The consideration of the audio object emotion being subjective may be taken care easily by maintaining the basic number of adaptive emotion kernels and adapting based on the feedback from the listener.

Referring to FIG. 8e, in an embodiment, the input may be vocals=47, and Background Music (BGM)=32 and the output may imply that the vocals contain 100% of the E5 (Extremely Happy) and the BGM contains 30% of the E3 (Normal) and 70% of the E4(Happy) by the composition factor determination engine 224.

Referring to FIG. 8f, in an embodiment, a shape of adaptive emotion kernel may be adapted by changing the size of adaptive emotion kernel according to an interest of the listener. “m₊” is a positive slope of the kernel, “m₋” is a negative slope of the kernel, and “c” is the height of the kernel.

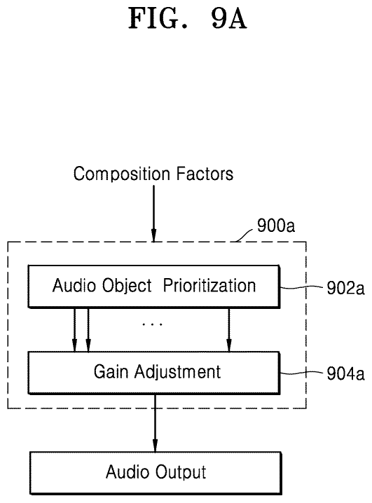

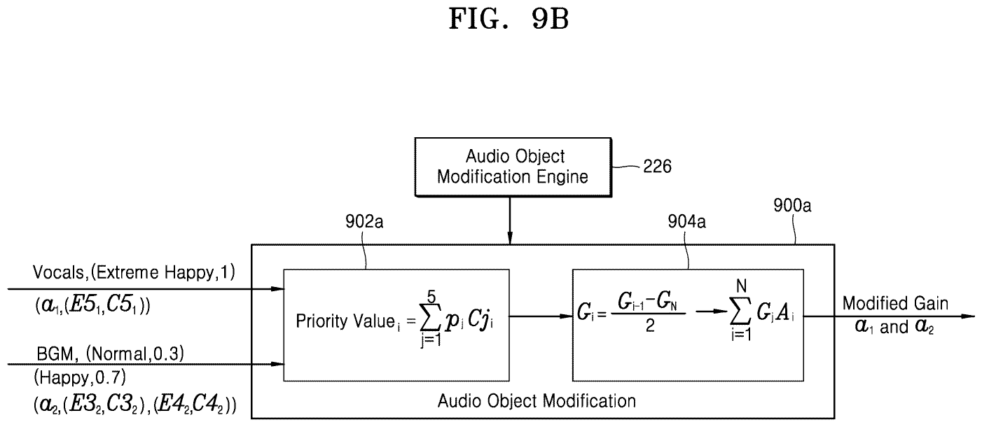

FIG. 9a illustrates an operational flow diagram 900a depicting a process for an audio object prioritization and gain adjustment, in accordance with an embodiment of the disclosure. FIG. 9b illustrates a diagram depicting the audio object prioritization and the gain adjustment for generating the modified audio content, in accordance with an embodiment of the disclosure. Referring to FIG. 9a and FIG. 9b, in an embodiment, the audio object prioritization may include calculating a probability of a listener associating with each of one or more basic emotions represented in the composition factor among a number of basic emotions and a priority value associated with each audio object among a number of audio objects based on the probability as depicted in FIG. 1. Further, the gain adjustment may include adjusting a gain associated with at least one audio object among the number of audio objects for modifying audio content. In an embodiment, upon gain adjustment of the at least one audio object, the number of modified audio objects may be combined to generate a modified audio content for the listener. In an embodiment, the audio object prioritization and gain adjustment may be performed by the audio object modification engine 226 as referred in the FIG. 2.

Continuing with the above embodiment, the audio object modification engine 226 may be configured to receive a composition factor (representing the number of basic emotions in each audio object (aᵢ, (Ejᵢ, Cjᵢ)), 1≤i≤N, 1≤j≤M) as an input from the composition factor determination engine 224 as referred in the FIG. 2. In an embodiment, ‘N’ may be the number of audio objects, “M” may be the number of basic emotions. In an embodiment, ‘j’ may be the one or more basic emotions among the number of basic emotions “M” represented in the composition factor. In an embodiment, the number of basic emotions “M” may be 5. In an embodiment, the number of basic emotions “M” may vary between 4 and 27. Further, in response to receiving the input, the audio object modification engine 226 may be configured to generate a prioritized list of the number of audio objects. Aᵢ, 1≤i≤N.

In an embodiment, the process may include a step 902a. At step 902a, the process may include determining a priority of a particular audio object from the number of audio objects based on preference information of a listener by the audio object modification engine 226.

In an embodiment, the priority value of each audio object aᵢ may be determined as follows:

Determining the probability of the listener associating with each of the one or more basic motions from the number of basic emotions: The probability of the listener associating with each of the one or more basic motions may be determined solely based on feedback from the listener. Alternatively, the information contained in a number of adaptive emotion kernels may be used to determine the probability based on equation 2:

$${p}_{j} = \frac{area contained in the Emotion kernel of Ej}{maximum area contained of all Emotion kernel} , 1 \leq j \leq M$$

where, Ej: is one of the basic emotions of E1, E2, E3, E4, E5 as explained earlier.

Determining the Priority Value: Once the probability of the listener associating with each basic emotion among the one or more basic emotions, pⱼ, is known, the priority value of each audio object aᵢ may be determined based on equation 3:
Priority Valueᵢ=Σⱼ₌₁^{M}pⱼCjᵢ; where, Cjᵢ is the composition factor of basic emotion Ej for audio object aᵢ

Once the priority value of each audio object is determined, the audio object modification engine 226 may be configured to sort the number of audio objects in an order of priority as:

Aᵢ=aₖ,
such that aₖ has the maximum priority value among the audio objects

$$\{ {a}_{k} - \{ {A}_{1} , … {A}_{i - 1} \} \} , 1 \leq i , k \leq N$$

Further, for performing the gain adjustment, audio object modification engine 226 may be configured to receive the prioritized audio object list Aᵢ, 1≤i≤N as the input and generate the modified audio content as the output.

In an embodiment, the audio object modification engine 226 may be configured to provide appropriate gains to the prioritized audio objects, so as to remove/reduce or enhance the particular audio object, based on the priority value, and also to mix the adjusted gain audio objects to generate a final modified audio output. In an embodiment, the final modified audio output may be the modified audio content. In an embodiment, the final modified output may be outputted through a sound output device such as a speaker. The sound output device may process a signal and output sound through a speaker.

In an embodiment, the process may include a step 904a. At step 904a, the process may include adjusting to the gains according to a preset preference set by the listener, given the prioritized audio object list Aᵢ, such that the priority of Aᵢ is greater than priority of Aᵢ₊₁; 1≤i≤N by the listener by the audio object modification engine 226. In an embodiment the preset preference may include an option to ask whether to completely remove some part of audio or to enhance or reduce the effect. In an embodiment, the gain adjustment must be handled appropriately for the following scenarios:

Completely removing a part of the audio content by assigning a gain of 0 to a least priority audio object (GN=0) and a gain of 1 to the highest priority audio object (G₁=1). In an embodiment, the least priority audio object may be an audio object in the prioritized audio object list with a lowest priority value and the highest priority audio object may be an audio object in the prioritized audio object list with a highest priority value.

Enhancing or reducing an effect by assign a non-zero gain to the least priority audio object (G_{N}>0) and a gain of 1 to the highest priority audio object (G₁>1).

Continuing with the above embodiment, once G_{N} and G₁ are set for the number of audio objects A_{N} and A₁ respectively, the gains for remaining audio objects Aᵢ may be determined based on equation 4:

$${G}_{i} = \frac{{G}_{i - 1} - {G}_{N}}{2}$$

Furthermore, on determining the gains, the modified output may be simply mixed based on equation 5:

$$Modified Audio Output = {\sum }_{i = 1}^{N} {G}_{i} {A}_{i}$$

Referring to FIG. 9b, in an embodiment, the audio object modification engine 226 may receive the number of audio objects such as vocals, and a BGM and generate a list of the audio objects based on the priority value. Further, based on the priority value, the modified audio content may be generated. In an embodiment, the vocals may represent an extreme happy emotion and a composition factor may be 0.9 and the BGM may represent a happy emotion, and a normal emotion with a composition factor of 0.3 and 0.7.

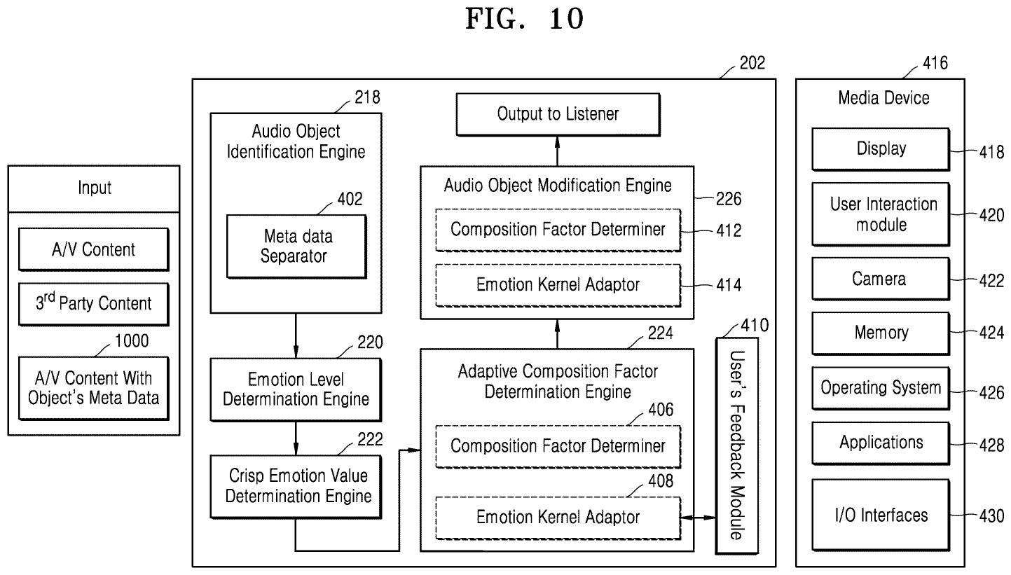

FIG. 10 illustrates an architectural diagram of a method to modify audio content comprising a meta-processor 1002, in accordance with an embodiment of the disclosure. In an embodiment, the architectural diagram 1000 may be an embodiment of the architectural diagram as depicted in the FIG. 4. Furthermore, the number of basic emotions on a common scale utilized by the crisp emotion value determination engine 220 may vary between 4 and 27. In another embodiment, the adaptive composition factor determination engine 224 may be configured to use feedback of a listener such that the feedback may be generated based on reinforcement learning.

Further, in an embodiment, the audio object identification engine 218 may use audio objects based codecs to utilize meta data 1000 related to audio object information such as Dolby Atmos rather than performing source separation of the audio content. In an embodiment, a meta data processor maybe deployed to process and find information of each audio object information directly from the input meta-data.

In an embodiment, a number of adaptive emotions kernels may be of a number of shapes. In an embodiment, the number of shapes may include a trapezium shape, a triangular shape, a circular shape, a rectangular shape or the like. The number of shapes may be changed/initialized according to the best suited using a trial and error method. The shape may further be adjusted using a reinforcement learning based feedback of a listener.

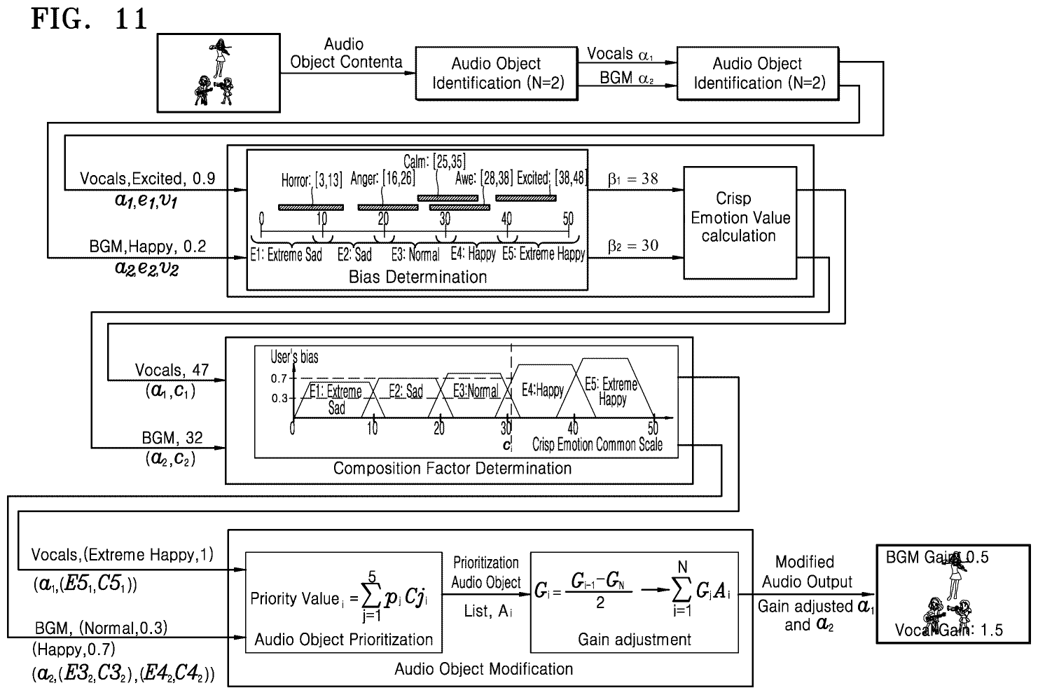

FIG. 11 illustrates a use case diagram depicting a scenario for modifying audio content by enhancing a voice of a singer, in accordance with an embodiment of the disclosure. Referring to FIG. 5d, FIG. 6b, FIG. 7d, FIG. 8e, FIG. 9b and FIG. 11, FIG. 11 illustrates the scenario for modifying audio content to enhance a signer's voice in accordance with the disclosure.

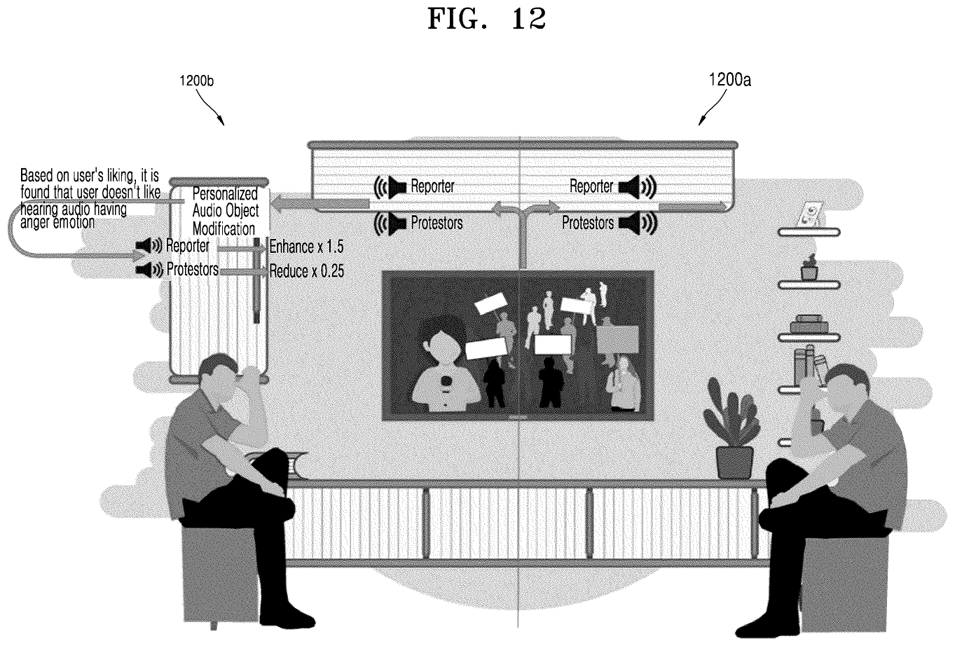

FIG. 12 illustrates a use case diagram 1200a depicting a scenario of a listener being unable to modify audio content, in accordance with a comparative example. The listener may not like loud audio or audio associated with anger/rage and may have to manually reduce volume of a Tele Vision (TV) playing the audio. However, on reducing the volume, the listener may not be able to hear a reporter clearly or if the listener increases the volume, a background noise of people in the TV may get louder. FIG. 12 illustrates a use case diagram 1200b depicting a scenario of the listener modifying the audio content, in accordance with an embodiment of the disclosure. In an embodiment, the listener may be relieved of reducing the volume of a particular audio object such as shouting by one or more persons, as a smart TV may understand a preference of the listener.

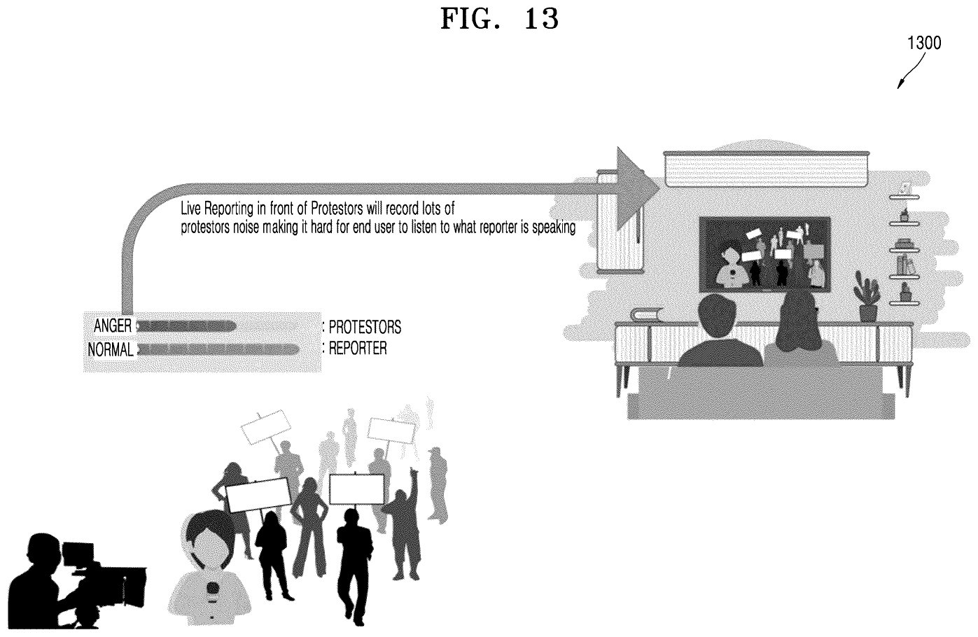

FIG. 13 illustrates a use case diagram 1300 depicting a scenario of a listener modifying audio content by managing one or more audio objects, in accordance with an embodiment of the disclosure. In an embodiment, the one or more audio objects may be related to audio object emotions such as anger and shouting. In an embodiment, the listener may not like audio containing anger and shouting and may be able to reduce an effect of the anger and shouting in the audio content. In an embodiment, the audio content may be of a live recording of one or more protestors making difficult for the listener to listen a report of the reporter with respect to the one or more protestors.

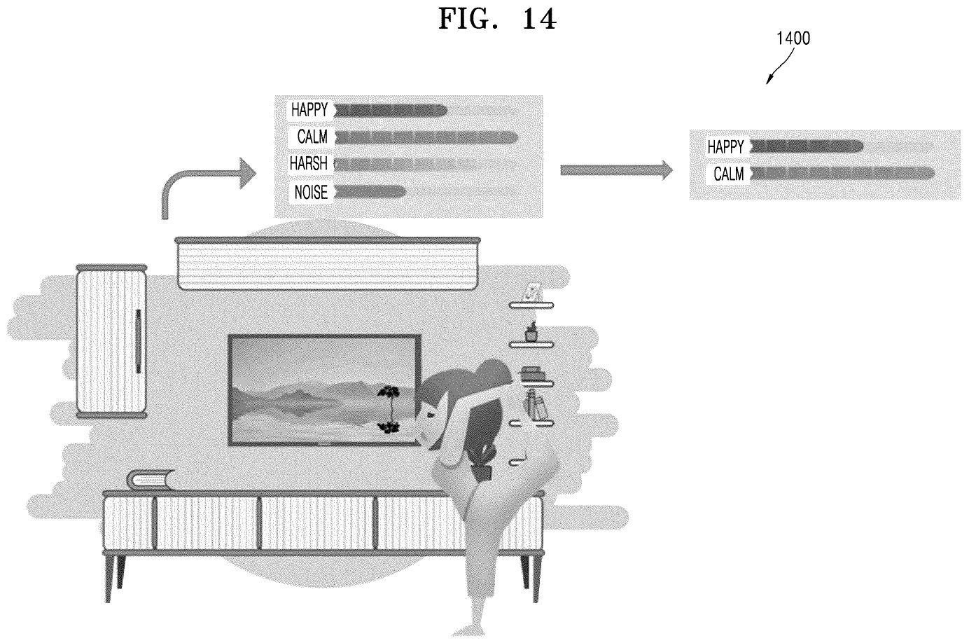

FIG. 14 illustrates a use case diagram 1400 depicting a scenario of a listener controlling one or more audio objects of audio content, in accordance with an embodiment of the disclosure. In an embodiment, the one or more audio objects may represent audio object emotions such as happy, calm, harsh, and noise. In an embodiment, the listener may be exercising and may increase an effect of an audio object among the one or more audio objects related to the calm audio object emotion by removing the audio objects representing the harsh emotion and the noise emotion.

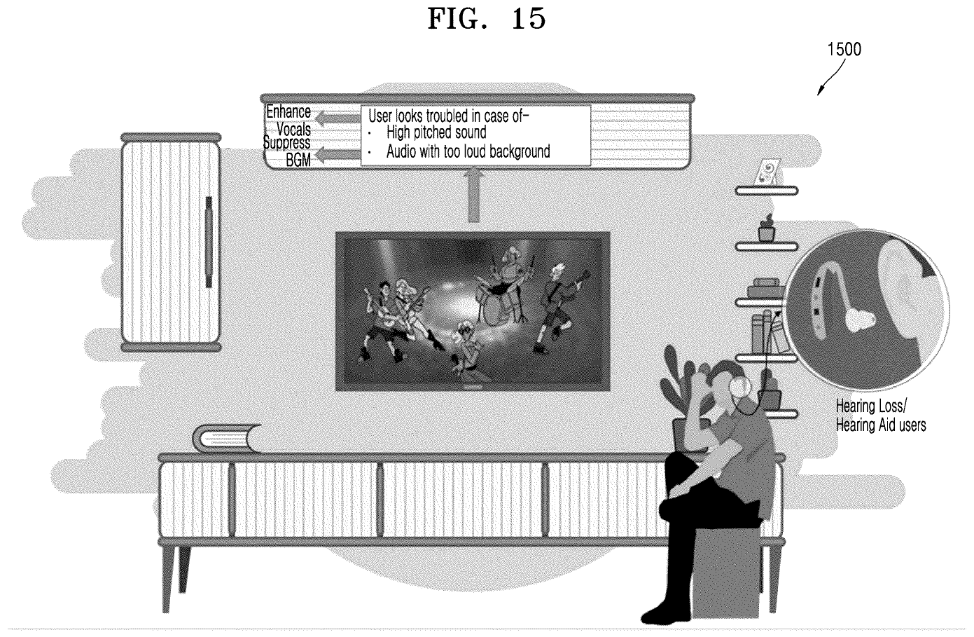

FIG. 15 illustrates a use case diagram 1500 depicting a scenario of a listener enhancing vocals and suppressing a BGM from audio content, in accordance with an embodiment of the disclosure. In an embodiment, the listener may be suffering from a hearing condition and utilizing a hearing aid that causes the listener to feel an audio signal as loud but unclear. In an embodiment, a system disclosed in the disclosure may be configured to understand a trouble or disinterest of the listener towards loud sounds making it unclear for the listener to understand, thus automatically suppressing the unwanted audio object.

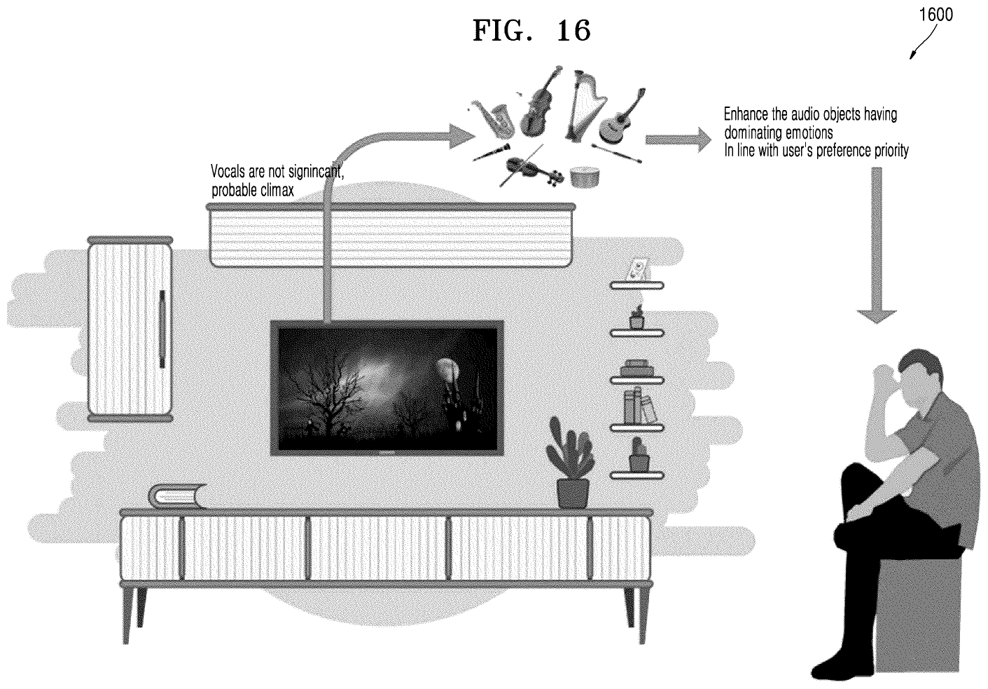

FIG. 16 illustrates a use case diagram 1600 depicting a scenario of an enhancement of a musical part in audio content, in accordance with an embodiment of the disclosure. In an embodiment, the musical part may be preferred by the listener and a system disclosed in the disclosure may be configured to detect the preference based on previous experiences and enhancing the musical part as preferred by the listener.

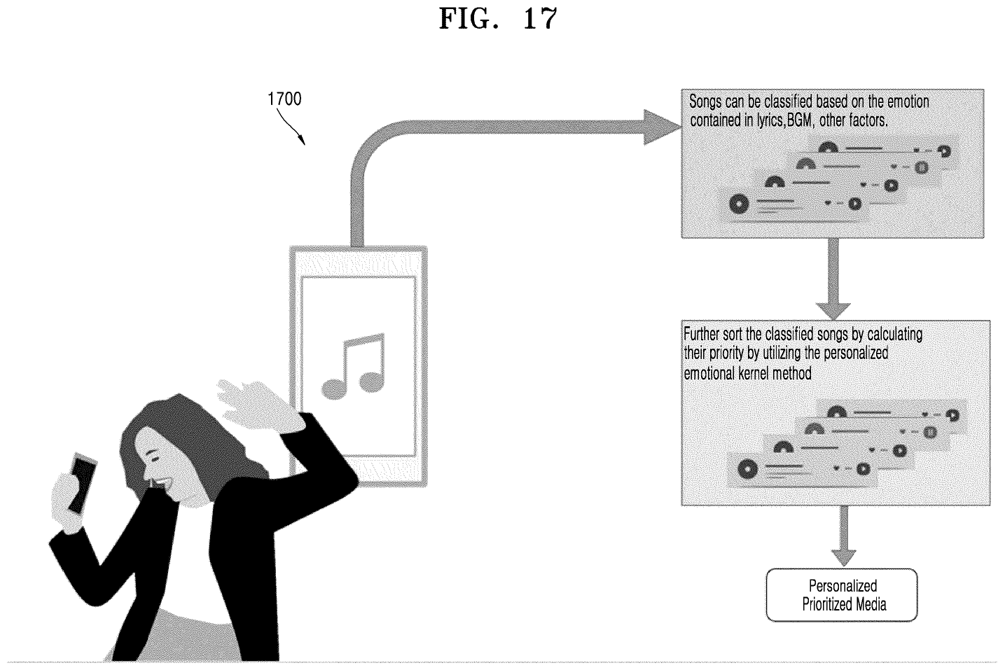

FIG. 17 illustrates a use case diagram 1700 depicting a scenario in which audio content may be personalized based on an emotion associated with the audio content, in accordance with an embodiment of the disclosure. In an embodiment, the audio content may be a song. In an embodiment, the song may be classified based on the emotion contained in lyrics, BGM, other factors associated with the song. Furthermore, a system disclosed in the disclosure may be configured to classify the song by calculating a priority by utilizing a personalized emotional kernel method.

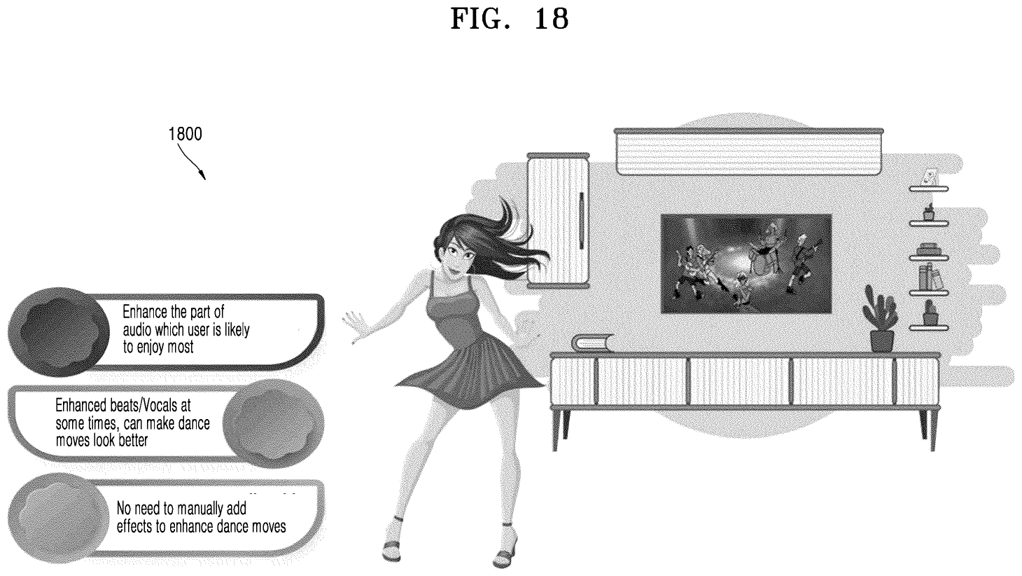

FIG. 18 illustrates a use case diagram 1800 depicting a scenario of automatic enhancement of vocals/beats in audio content, in accordance with an embodiment of the disclosure. In an embodiment, the enhancement may be performed based on a preference of a listener by a system disclosed in the disclosure while the listener is dancing. In an embodiment, the system may be configured to enhance a part of the audio content the listener is likely to enjoy along with the vocals/beats in some part of the audio content without having to manually enhance dance moves of the listener dancing while listening to the audio content.

While specific language has been used to describe the disclosure, any limitations arising on account of the same are not intended. As would be apparent to a person in the art, various working modifications may be made to the method in order to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method for modifying audio content, the method comprising:
determining a crisp emotion value defining an audio object emotion, for each audio object among a plurality of audio objects associated with an audio content, the plurality of audio objects being at least some of a total number of audio objects associated with the audio content;
determining a composition factor representing one or more emotions, among a plurality of emotions, in the crisp emotion value of each audio object;
calculating a probability of a user associating with each of the one or more emotions represented in the composition factor;
calculating a priority value for each audio object based on the probability of the user associating with each of the one or more emotions represented in the composition factor of each audio object and the composition factor of each audio object;
generating a list comprising the plurality of audio objects in a specified order based on the priority value of each audio object among the plurality of audio objects; and
modifying the audio content by adjusting a gain of at least one audio object among the plurality of audio objects in the list.

2. The method as claimed in claim 1, further comprising:
generating a modified audio content by combining a plurality of modified audio objects.

3. The method as claimed in claim 1, wherein determining the crisp emotion value for each audio object comprises:
determining a range of the audio object emotion of the plurality of audio objects by mapping an audio object emotion level for each audio object on a common scale,
wherein the common scale comprises the plurality of emotions;
determining a bias of the audio object emotion level for each audio object,
wherein the bias is a minimum value of the range; and
determining the crisp emotion value for each audio object by adding the audio object emotion level of each audio object mapped on the common scale to the bias.

4. The method as claimed in claim 3, wherein the common scale is one of a hedonic scale and an arousal scale.

5. The method as claimed in claim 1, wherein the determining the composition factor comprises:
mapping the crisp emotion value of each audio object on a kernel scale comprising a plurality of adaptive emotion kernels representing the plurality of emotions,
wherein the composition factor is based on a contribution of the one or more emotions among the plurality of emotions represented by one or more adaptive emotion kernels in the crisp emotion value of each audio object.

6. The method as claimed in claim 5, further comprises:
obtaining a plurality of feedback parameters associated with the user from at least one of a memory and the user in real-time; and
adjusting a size of at least one adaptive emotion kernel among the plurality of adaptive emotion kernels based on the plurality of feedback parameters.

7. The method as claimed in claim 5, wherein the contribution of the one or more emotions is determined based on the mapping the crisp emotion value of each audio object on the one or more adaptive emotion kernels.

8. The method as claimed in claim 1, wherein the calculating the probability of the user associating with each of the one or more emotions represented in the composition factor is based on at least one of:
a plurality of feedback parameters associated with the user stored in a memory; and
a ratio of an area of one or more adaptive emotion kernels corresponding to each emotion represented in the composition factor and a total area of a plurality of adaptive emotion kernels of the plurality of emotions.

9. The method as claimed in claim 6, wherein the plurality of feedback parameters comprises at least one of a visual feedback, a sensor feedback, a prior feedback, and a manual feedback associated with the user.

10. The method as claimed in claim 1, wherein the calculating the priority value for each audio object comprises:
performing a weighted summation of the probability of the user associating with each of the one or more emotions represented in the composition factor and the composition factor representing the one or more emotions.

11. The method as claimed in claim 1, wherein the modifying the audio content by adjusting the gain of at least one audio object comprises:
performing one or more of:
assigning a first gain to an audio object in the list corresponding to a highest priority value and a second gain to another audio object in the list corresponding to a lowest priority value, wherein assigning the second gain corresponds to an audio object being removed from the audio content, and
assigning a third gain, greater than the second gain, to the audio object corresponding to a lowest priority value, and the first gain to an audio object corresponding to a highest priority value, wherein assigning the third gain corresponds to an effect of the audio object being changed;
calculating a gain of one or more audio objects in the list, other than the audio object with the highest priority value and the other audio object with the lowest priority value, based on a gain associated with an audio object with a priority value higher than the one or more audio objects and a gain associated with the audio object with a priority value lower than the one or more audio objects; and
performing a weighted summation of a gain associated with each audio object in the list for modifying the audio content.

12. The method as claimed in claim 1, further comprising:
receiving the audio content as an input;
separating the audio content into the total number of the audio objects; and
determining an audio object emotion level for each audio object among the plurality of audio objects.

13. The method as claimed in claim 12, wherein the separating the audio content into the plurality of audio objects comprises:
generating a pre-processed audio content by pre-processing the input;
generating an output by feeding the pre-processed audio content to a source- separation model; and
generating the plurality of audio objects associated with the audio content from the audio content by post-processing the output.

14. The method as claimed in claim 12, wherein the audio object emotion level of each audio object is determined by:
determining one or more audio features associated with each audio object,
wherein the one or more audio features comprise at least one of a basic frequency, a time variation characteristic of a frequency, a Root Mean Square (RMS) value associated with an amplitude, and a voice speed associated with each audio object;
determining an emotion probability value of each audio object based on the one or more audio features; and
determining the audio object emotion level of each audio object based on the emotion probability value.

15. The method as claimed in claim 1, further comprising:
controlling a speaker to output the modified audio content according to the adjusted gain of the at least one audio object.

16. A system for modifying audio content for a listener, the system comprising:
a memory storing instructions; and
at least one processor configure to execute the instructions,
wherein, by executing the instructions, the at least one processor is configured to:
determine a crisp emotion value defining an audio object emotion, for each audio object among a plurality of audio objects associated with the audio content, the plurality of audio objects being at least some of a total number of audio objects associated with the audio content;
determine a composition factor representing one or more emotions in the crisp emotion value of each audio object among a plurality of emotions;
calculate a probability of a user associating with each of the one or more emotions represented in the composition factor;
calculate a priority value for each audio object based on the probability of the user associating with each of the one or more emotions represented in the composition factor of each audio object and the composition factor of each audio object;
generate a list comprising the plurality of audio objects in a specified order based on the priority value of each audio object among the plurality of audio objects; and
modify the audio content by adjusting a gain of at least one audio object among the plurality of audio objects in the list.

17. The system as claimed in claim 16, further comprising:
an input interface operatively connected to the processor and configured to input the audio content, and
a speaker operatively connected to the processor and configured to output sound corresponding to the inputted audio content,
wherein, by executing the instructions, the at least one processor is further configured to:
control the speaker to output the modified audio content according to the adjusted gain of the at least one audio object.

18. A non-transitory computer-readable information storage medium having instructions stored therein, which, when executed by one or more processors, cause the one or more processors to:
receive, through an input interface, audio content;
separate the audio content into a plurality of audio objects;
for at least some of the plurality of audio objects, respectively:
determine a crisp emotion value defining an audio object emotion,
determine a composition factor representing one or more emotions, among the plurality of emotions, in the crisp emotion value,
calculate a probability of a user associating with each of the one or more emotions represented in the composition factor, and
calculate a priority value based on the probability of the user associating with each of the one or more emotions represented in the composition factor and the composition factor;
generate a list comprising the plurality of audio objects in a specified order based on the priority value of each audio object among the plurality of audio objects;
modify the audio content by adjusting a gain of at least one audio object among the plurality of audio objects in the list;
control a speaker to output the modified audio content.

19. The non-transitory computer-readable information storage medium as claimed in claim 18, wherein the calculating the probability of the user associating with each of the one or more emotions represented in the composition factor is based on at least one of:
a plurality of feedback parameters associated with the user stored in a memory; and
a ratio of an area of one or more adaptive emotion kernels corresponding to each emotion represented in the composition factor and a total area of a plurality of adaptive emotion kernels of the plurality of emotions.

20. The non-transitory computer-readable information storage medium as claimed in claim 18, wherein the separating the audio content into the plurality of audio objects comprises:
generating a pre-processed audio content by pre-processing the input;
generating the output by feeding the pre-processed audio content to a source-separation model; and
generating the plurality of audio objects associated with the audio content from the audio content by post-processing the output.
